(19) United States
(12) Patent Application Publication
(10) Pub. No.: US 2026/0184589 A1
(43) Pub. Date: Jul. 2, 2026

(54) METHODS FOR PREPARING AMORPHOUS CALCIUM CARBONATE BY FIXATION OF CARBON DIOXIDE

(71) Applicant: Amorphical Ltd., Ness Ziona (IL)

(72) Inventors: Yossi BEN, Moshav Zofer (IL); Yigal Dov BLUM, San Jose, CA (US); Eden BEN, Moshav Zofer (IL); Ben ASHKENAZI, Ofakim (IL); Roni Antoine ILLOS, Ashkelon (IL)

(21) Appl. No.: 19/127,523

(22) PCT Filed: Nov. 8, 2023
(86) PCT No.: PCT/IL2023/051148

§ 371 Date: May 6, 2025

Related U.S. Application Data
(60) Provisional application No. 63/423,512, filed on Nov. 8, 2022.

(51) Int. Cl. C01F 11/18

(52) U.S. Cl. CPC C01F 11/181; C01P 2002/02; C01P 2002/88; C01P 2006/12

(57) ABSTRACT

The present invention provides methods for fixating carbon dioxide and preparation of stabilized amorphous alkaline earth metal carbonate.

### FIELD OF THE INVENTION

The present invention relates to methods of preparing stabilized amorphous calcium carbonate using and fixating carbon dioxide gas.

### BACKGROUND OF THE INVENTION

Climate change is identified as a major challenge of contemporary society. Driven by greenhouse gases in general, carbon dioxide (CO₂) as the most common one is a principal contributor to global warming. Over 40% of energy-related CO₂ emissions are due to the burning of fossil fuels for electricity generation.

Inorganic carbonation processes were previously suggested and even practiced to fixate CO₂ mainly generated by power plants and other energy-consuming manufacturing facilities. In these cases, the idea is to capture the exhausting CO₂ in a controlled fashion and then release it again in a controlled fashion by filling CO₂ reservoirs, dumping it into deep seas, and absorbing it in certain geological compositions. The existing processes have drawbacks such as energy consumption, efficacy and costs of the process (partially to high cost of mineral reagents). They are also based on using capturing agents, e.g., Ca(OH)₂ and CaO, produced by releasing CO₂ from earthly mined CaCO₃, or ammonia. These processes also require the release and trapping of the CO₂ elsewhere in an energy-consuming process, while there is still a need to dump (“store”) this CO₂ elsewhere on earth or convert it to practical organic products. The latter concept is already studied for 40 years without any large scale, low energy consumption, and useful potential for commercializing the derived products.

It is very well known that in basic conditions (i.e., high pH, high concentrations of OH⁻), CO₂ can transform into bicarbonate or carbonate (depending on the pH). It is also well known that calcium ionic salts such as calcium chloride and calcium nitrate, in particular, can convert to Ca(OH)₂, which can then react with CO₂ to form crystalline CaCO₃.

The solubility of CO₂ at atmospheric pressure and at 25° C. is very low, about 1.5 g of CO₂ is dissolved in 1 L of water at atmospheric pressure. The low dissolved quantity of CO₂ in water at room temperature and at atmospheric pressure, causes the likelihood of capturing high volumes of rapidly released CO₂ by a calcium reagent such as CaCl₂)·2H₂O, calcium nitrate and Ca(OH)₂ impractical unless raising the pressure, in closed reactors.

The CO₂ solubility vs pressure graphs generally demonstrates that at 1 atm the solubility in water is about 1.5 g per 1 Kg of water at 25° C., slightly dependent on the water content. The solubility increases dramatically when the CO₂ is pressurized. At about 50 atm the solubility reaches over 50 g CO₂ per 1 Kg of water. Hence, one way for increasing the efficiency of the process, described in this invention, is to introduce the CO₂ in a pressurized mode.

Chemical equilibrium shifts the conversion reaction of predominately CO₂ at pH 5 to predominantly (over 90%) bicarbonate and finally carbonate at pH levels of 7, and 11, respectively. At pH levels below 4 and 5 the CO₂ converts to carbonic acid, which intensifies the acidity of the water solution and maintains most of the CO₂ in is original form.

The massive production of other carbonates and minerals is sometimes involved with the large production of CaCl₂) and CaSO₄ hydrates as industrial waste. For example, CaCl₂ is the by-product of soda ash (Na₂CO₃) in a process known as the “Solvay Process”. Park et al., (Journal of Hazardous Materials 403 (2021) 123862) discloses use of the process of conversion of Ca(OH)₂ to calcium carbonate by its reacting with CO₂. If such industrial wastes can be reutilized at no or a fraction of their cost, the economics for capturing CO₂ in any form of calcium carbonate will compensate for the costs associated with continuous CO₂ capture.

Due to global industrialization in parallel to the dangerous greenhouse effect, and climate change, there is an urgent need to develop new techniques for removing CO₂ from the atmosphere.

### SUMMARY OF THE INVENTION

It was unexpectedly found that by adjusting physicochemical conditions it is possible to fixate CO₂ gas and produce a high quantity of stabilized amorphous calcium carbonate at room temperature in an industrially profitable way. In the lab-scale reactions provided in the examples about 3.8 g of CO₂ were reacted with about 13 g of CaCl₂·2H₂O for synthesizing ACC in the presence of a stabilizer such as tripolyphosphate (as a representative stabilizer) with an overall yield of 10.5 g, in a 250 ml reaction volume solution at room temperature, provided that the CO₂ is converted to CO₃. Examples show that it is possible to achieve up to 90% yield of ACC production and 90% phase purity (i.e., amorphous material). It is shown in the present invention that by adding CO₂ to a basic solution and obtaining in-situ the soluble form of (Na)₂CO₃ as the first step increased the yield. Alternatively, the base can be added to solutions of calcium chloride or nitrate, converting them in-situ into calcium hydroxide, which captures CO₂ to form ACC in the presence of stabilizers.

In addition, it is possible to increase the yield of ACC production by changing the schedule of adding a stabilizer and/or by increasing the pH of the reaction. As shown in example 2, by adding the stabilizer in two different stages, the yield increases.

Without being limited to any particular theory, it is estimated that three to four balanced reactions take place.

The main reactions are:

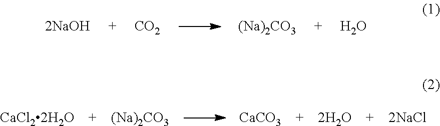

Additional reactions that may occur after the addition of CaCl₂) are:

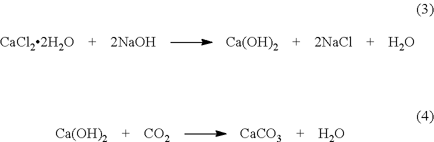

In the laboratory conditions, we concluded that the reaction may be completed in less than two minutes. Similar reaction can be performed in the presence of dissolved ammonia (hence NH₄OH). NH₄OH means the product of dissolving ammonia (NH₃) in water. Hence, the reactions with this base can be processed by either using predissolved ammonia, already defined as NH₄OH or by direct bubbling or pressurizing ammonia into the reaction solution, forming in-situ the NH₄OH.

By fixating CO₂ and converting CaCl₂) to ACC the present invention solves in fact three problems: fixating environmentally hazardous CO₂, disposal of CaCl₂) waste and production of ACC in large quantities. The ACC may be used in agriculture, e.g., as crop fertilization, as a supplement to livestock animals etc., when it is produced at a lower purity required for its use as a food supplement or medication. In some industrial processes, calcium oxide can be generated as a byproduct. Although it can be used for forming cement and glass, it can also be used to form calcium hydroxide which can be converted to ACC according to this invention. Similar processes can be performed by using MgCl₂, Mg(NO₃)₂, MgSO₄, Mg(OH)₂ and MgO waste products in the presence of base, stabilizers and CO₂ bubbling to obtain amorphous magnesium carbonate phases.

Maintaining adequate high pH (above 8) throughout the process is important by adding enough base (2 equivalent or more of the calcium present in the reaction) or continuous or incremental addition of a base for maintaining a pH above 8 and preferably above 11. In general, it is possible to achieve the formation of calcium carbonate precipitation also below pH 10 but then most of the CO₂ is in the form of dissolved bicarbonate and the calcium carbonate, obtained by partial decomposition of the bicarbonate back to CO₂ is generated at low yield. A higher pH than 11 is also an option, as it may affect the primary particle size and the amorphous phase of the calcium carbonate.

The use of clean and content-controlled amorphous calcium carbonate (ACC) for a broad range of biomedical applications has been already demonstrated and reported in a series of patents and publications. Lesser clean ACC but at very large quantities can be utilized as advantageous fertilizer and feedstock for animals such as chicken and cattle, provided that there are no more than ppm levels of poisonous metals in the calcium-based byproduct. If such ACC can be produced at a fraction of the cost of the currently used ACC as a food supplement or drug, it will enhance and improve agriculture crops, the quality of fruits and vegetables, and healthier livestock.

According to one aspect, the present invention provides a method of preparing a stabilized amorphous alkaline earth metal carbonate, the method comprising:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; or
   adding a salt of an alkaline earth metal into the solution obtained in step (i) followed by bubbling or pressurizing CO₂ gas into the solution,
   thereby precipitating an amorphous alkaline earth metal carbonate, and
(iii) collecting the resulting stabilized amorphous alkaline earth metal carbonate precipitate,
   wherein the method comprises adding at least one stabilizer in at least one of the following stages: (a) before bubbling or pressurizing CO₂ gas; (b) after bubbling or pressurizing CO₂ gas; (c) before adding a salt of an alkaline earth metal, (d) together with adding a salt of an alkaline earth metal, or (e) after adding a salt of an alkaline earth metal.

According to some embodiments, the stabilizer is added after bubbling or pressurizing CO₂ gas and together with adding a salt of an alkaline earth metal.

According to some embodiments, the method comprises:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; and
(iii) collecting the resulting stabilized amorphous alkaline earth metal carbonate precipitate.

In some embodiments, the method comprises adding a stabilizer before bubbling or pressurizing CO₂ gas into the solution obtained in step (i). In some embodiments, the method comprises adding a stabilizer after adding the salt of an alkaline earth metal. In some embodiments, the method comprises adding a stabilizer before bubbling or pressurizing CO₂ gas into the solution obtained in step (i) and after adding the salt of an alkaline earth metal.

According to some embodiments, the method comprises:
(i) dissolving a base in an aqueous solution, wherein the resulting solution has a pH equal to or above 8;
(ii) adding a salt of an alkaline earth metal into the solution obtained in step (i) followed by bubbling or pressurizing CO₂ gas into the solution,
(iii) collecting the resulting stabilized amorphous alkaline earth metal carbonate precipitate.

According to some embodiments, the method comprises adding a stabilizer together with adding the salt of an alkaline earth metal. According to some embodiments, the method comprises adding a stabilizer before bubbling or pressurizing CO₂ gas into the solution obtained in step (i). According to some embodiments, the method comprises adding a stabilizer together with adding the salt of an alkaline earth metal and further before bubbling or pressurizing CO₂ gas.

According to some embodiments, the method comprises, as a first step, dissolving a base and a stabilizer in an aqueous solution. Therefore, according to some embodiments, the present invention provides a method of preparing a stabilized alkaline earth metal carbonate, the method comprising:
(i) dissolving a base and a stabilizer in an aqueous solution, wherein the resulting solution has a pH equal to or above 8;
(ii) bubbling or pressurizing CO₂ gas into the solution obtained in step (i) followed by adding a salt of an alkaline earth metal and optionally adding a stabilizer to the solution; or adding a salt of an alkaline earth metal into the solution obtained in step (i) followed by bubbling or pressurizing CO₂ gas into the solution and optionally adding a stabilizer,
   thereby precipitating the stabilized amorphous alkaline earth metal carbonate;
(iii) optionally adding a stabilizer to the solution obtained in step (ii), and
(iv) collecting the resulting stabilized amorphous alkaline earth metal carbonate,
   wherein CO₂ is introduced into the solutions constantly during steps (ii) and (iii), if present, and the stabilizer in steps (i) and in steps (ii) and/or (iii), if present, is the same or different.

According to some embodiments, step (ii) comprises bubbling or pressurizing CO₂ gas into the solution obtained in step (i) followed by adding a salt of an alkaline earth metal. Therefore, according to some embodiments, the method comprises the steps of:
(i) dissolving a base and a stabilizer in an aqueous solution;
(ii) bubbling or pressurizing CO₂ gas into the solution obtained in step (i) followed by adding a salt of an alkaline earth metal and optionally adding a stabilizer to the solution;
(iii) optionally adding a stabilizer to the solution obtained in step (ii), and
(iv) collecting the resulting stabilized amorphous alkaline earth metal carbonate.

According to another embodiment, step (ii) comprises adding a salt of an alkaline earth metal into the solution obtained in step (i) followed by bubbling or pressurizing CO₂ gas into the solution. Thus, according to some embodiments, the method comprises the steps of:
(i) dissolving a base and a stabilizer in an aqueous solution;
(ii) adding a salt of an alkaline earth metal and optionally adding a stabilizer to the solution obtained in step (i) followed by bubbling or pressurizing CO₂ gas;
(iii) optionally adding a stabilizer to the solution obtained in step (ii), and
(iv) collecting the resulting stabilized amorphous alkaline earth metal carbonate.

According to some embodiments, the present invention provides a method of preparing a stabilized amorphous alkaline earth metal carbonate, the method comprising:
(i) dissolving a base in an aqueous solution;
(ii) dissolving a stabilizer in the solution obtained in step (a) and bubbling or pressurizing CO₂ gas into the solution, wherein dissolving the stabilizer and starting the CO₂ introduction by bubbling or pressurizing is performed in either order;
(iii) adding a salt of an alkaline earth metal and optionally a stabilizer to the solution obtained in step (b), thereby precipitating the stabilized amorphous carbonate of the alkaline earth metal; and
(iv) optionally adding a stabilizer to the solution obtained in step (c), wherein CO₂ is introduced into the solutions constantly during steps (b) and (c), and the stabilizer in steps (b) and in steps (c) and/or (d), if added, is the same or different.

According to some embodiments, the pH of the solution obtained after the addition of the base in step (i) is equal to or above 8, equal to or above 9, equal to or above 10, equal to or above 11, or equal to or above 12. According to some embodiments, the pH of the solution obtained in step (i) is equal to or above 9. According to some embodiments, the pH of the solution obtained in step (i) is equal to or above 10. According to some embodiments, the pH of the solution obtained in step (i) is equal to or above 11. According to some embodiments, the pH of the solution obtained in step (i) is equal to or above 12. The term “pH equal to or above X” may be replaced by any one of the terms “pH equal to X”, “pH of more than X”, “pH higher than X”, pH of X or more” etc.

According to some embodiments, the precipitation of the amoshpous alkaline earth metal carbonate is accomplished within 2 minutes.

According to some embodiments, the method comprises adding a stabilizer at step (ii). Therefore, according to some embodiments, step (ii) comprises bubbling or pressurizing CO₂ gas into the solution obtained in step (i) followed by adding a salt of an alkaline earth metal and adding a stabilizer. According to other embodiments, step (ii) comprises adding a salt of an alkaline earth metal and a stabilizer to the solution obtained in step (i) followed by bubbling or pressurizing CO₂ gas. According to some embodiments, the stabilizer added in step (i) and step (ii) is the same stabilizer. According to some embodiments, the stabilizers added in step (i) and step (ii) are different stabilizers.

According to some embodiments, the method comprises adding a stabilizer in steps (i) and step (ii) only. According to some embodiments, the method comprises adding a stabilizer at step (iii). According to some embodiments, the method comprises adding a stabilizer in steps (i) and step (iii) only. According to some embodiments, the stabilizer added in step (i) and step (iii) is the same stabilizer. According to some embodiments, the stabilizers added in step (i) and step (iii) are different stabilizers. According to some embodiments, the method comprises adding a stabilizer in steps (ii) and step (iii). According to some embodiments, when the stabilizer is added in multiple steps, the stabilizers may be different in each step. According to other embodiments, the stabilizer in all steps may be the same stabilizer. In some examples, the method comprises adding the stabilizer at step (iv). In some examples, the stabilizer in step (ii) and step and step (iv) is the same stabilizer. A similar process can be used with other alkaline earth by-products. In an alternative process, the base and the stabilizers can be (i) added to the alkaline earth metal solution or slurry, and then (ii) the CO₂ can be purged to form the amorphous metal carbonate. All the stabilizer's quantity can be added at once into the solution prior to the CO₂ purge. In other cases, the stabilizer can be partially added to the solution before the purging and partially after the purging.

In some examples, the process is performed in batches. In other examples, the process can be performed in a series of batch reactors. In some examples, the process can be continuously performed. In this case, the completion time is not a factor but the time to remove the formed product is best to be done within a few minutes, preferably less than 10 minutes, less than 5 minutes, less than 3 minutes or less than or equal to 2 minutes.

According to some embodiments, the present invention provides a continuous method o of preparing a stabilized amorphous alkaline earth metal carbonate, the method comprises: providing an aqueous solution having a pH equal to or above 8 and: (i) continuously adding to the aqueous solution a base, at least one stabilizer, and an alkaline earth metal, (ii) continuously bubbling or pressurizing CO₂ gas into the solution, and (iii) continuously collecting the resulting amorphous alkaline earth metal carbonate precipitate, wherein the pH is constantly maintained equal to or above 8 during the whole process.

In some examples, the base is selected from a hydroxide of an alkali metal, ammonia or ammonium hydroxide. In some embodiments, the base is sodium hydroxide. In another embodiment, the base is ammonium hydroxide.

In any one of the above and below embodiments, the salt of an alkaline earth metal is water-soluble. In some examples, the salt of an alkaline earth metal is selected from a water-soluble halide, nitrate and sulfate salts of the metal, and hydrates thereof. In some examples, the alkaline earth metal salt is selected from calcium chloride, calcium bromide, calcium nitrate, magnesium chloride, magnesium sulfate magnesium nitrate and a combination thereof. In one example, the alkaline earth metal salt is calcium chloride. In some examples, the alkaline earth metal salt is magnesium chloride. In other examples, the alkaline earth metal is magnesium sulfate. In another embodiment, the alkaline earth metal salt is a combination of calcium chloride and magnesium sulfate. According to some embodiments, the method comprises adding the alkaline earth metal salt and/or maintaining its concentration of from 0.02 M to 0.1 M (molar, mol/L). According to some embodiments, the method comprises adding CaCl₂) and/or maintaining its concentration in the range of from 0.03 M to 0.8 M. According to some embodiments, the method comprises adding MgSO₄ and/or maintaining its concentration in the range of from 0.04 M to 1M.

In some examples, the stabilizer is selected from the group consisting of polyphosphates, inorganic polyphosphates, organic acids, phosphorylated amino acids, phosphorylated, phosphonated, sulfated or sulfonated organic compounds, phosphoric or sulfuric esters of hydroxy carboxylic acids, bisphosphonates, organic polyphosphates, polyphosphates, hydroxyl bearing organic compounds, derivatives thereof, proteins, any salts thereof and any combinations thereof. In some examples, the stabilizer is selected from the group consisting of tripolyphosphate or a salt thereof, phosphoserine, citric acid, sodium triphosphate and citric acid, adenosine triphosphate, adenosine diphosphate, phytic acid, etidronic acid, pyrophosphate, polyphosphate, hexamethaphosphate, ethanol, a salt thereof and any combination thereof. In some examples, the stabilizer is sodium tripolyphosphate. In some embodiments, the stabilizer is selected from triphosphate, pyrophosphate, hexametaphosphate, phytic acid, citric acid and a combination thereof. According to one embodiment, the stabilizer is a combination of triphosphate and pyrophosphate, or a combination of triphosphate and hexametaphosphate, or a combination of triphosphate and phytic acid or a combination of triphosphate and citric acid.

In some examples, the pH in step (i) is above 8, above 10, or above 12. In some examples, the pH in step (i) is from 8 to 13, from 8 to 12, from 9 to 12, from 9 to 11, from 10 to 12 or from 10 to 13.

In some examples, the pH is maintained at the value equal to or above 8, equal to or above 9, equal to or above 10, equal to or above 11, or equal to or above 12 during the whole process of preparation. In some examples, the pH is maintained at the value of from 8 to 13, from 8 to 12, from 9 to 12, from 9 to 11, from 10 to 12 or from 10 to 13 during the whole process of preparation.

In some examples, the amount of the base is at least 2 molar equivalents of the amount of the alkaline earth metal salt. In some examples, the concentration of the base is at least 2 molar equivalents of the concentration of the alkaline earth metal salt. In some examples, the concentration of the base is maintained to be at least 2 molar equivalents of the concentration of the alkaline earth metal salt.

The term “at least X” and “X or more” has the meaning of the value X or more. The term may be replaced by a phrase limiting the upper limit as defined in the embodiments of the application.

In some examples, the total amount of the stabilizer added is from 2 to 15 wt % of the amount of the alkaline earth metal salt. In some examples, the cumulative concentration of the stabilizer added is from 2 to 15 wt % of the concentration of the alkaline earth metal salt. In some examples, the cumulative concentration of the stabilizer added is kept constant to be from 2 to 15 wt % of the concentration of the alkaline earth metal salt.

In some examples, the reaction is performed at atmospheric pressure. In some examples, the reaction is performed under pressure from 1 to 60 bars.

In some examples, wherein the reaction is performed at ambient temperature.

In some examples, the precipitation of the stabilized amorphous alkaline earth metal carbonate, e.g., ACC and AMC e.g., in step (iii) is accomplished within from 2 to 3 minutes optionally followed by adding the stabilizer at step (iv).

According to some embodiments, the whole process of precipitation of the stabilized amorphous alkaline earth metal carbonate, e.g., ACC and AMC is accomplished within 2 minutes from the initiation of the precipitation.

According to some embodiments, collecting the stabilized amorphous alkaline earth metal carbonate comprises filtering and/or drying the resulting amorphous alkaline earth metal carbonate precipitant.

In some examples, the present invention provides a method comprising the steps of:
(i) dissolving a base and sodium tripolyphosphate as a stabilizer in an aqueous solution, wherein the pH of the resulting aqueous solution is 8 or more;
(ii) bubbling or pressurizing CO₂ into the solution obtained in step (i) followed by adding a CaCl₂) and optionally adding sodium tripolyphosphate as a stabilizer to the solution;
(iii) optionally adding sodium tripolyphosphate as a stabilizer to the solution obtained in step (ii), and
(iv) collecting the resulting stabilized amorphous calcium carbonate,
   wherein the base is selected from NaOH and NH₄OH and is added in the amount equal to at least 2 equivalents of CaCl₂) and optionally wherein CaCl₂) is selected from anhydrous, monohydrate and dihydrate CaCl₂). In some embodiments, the method comprises adding the stabilizer at step (iii). In some embodiments, the base is selected from NaOH or NH₄OH and is added in the amount equal to 2 or 3 molar equivalents of CaCl₂). According to some embodiments, the pH is maintained at the value equal to or above 8, equal to or above 9, equal to or above 10, equal to or above 11, or equal to or above 12 during the whole process of preparation. According to some embodiments, the pH is maintained at a value between 8 and 13 during the whole process of preparation.

In some examples, the present invention provides a method comprising the steps of:
(i) dissolving a base and sodium tripolyphosphate as a stabilizer in an aqueous solution, wherein the pH of the resulting aqueous solution is 8 or more;
(ii) adding CaCl₂) followed by bubbling or pressurizing CO₂ gas;
(iii) optionally adding sodium tripolyphosphate as a stabilizer to the solution obtained in step (ii), and
(iv) collecting the resulting stabilized amorphous calcium carbonate,
   wherein the base is selected from NaOH and NH₄OH and is added in the amount equal to at least 2 equivalents of CaCl₂) and optionally wherein CaCl₂) is selected from anhydrous, monohydrate or dihydrate CaCl₂). In some embodiments, the method comprises adding the stabilizer at step (iii). In some embodiments, the base is selected from NaOH or NH₄OH and is added in the amount equal to 2 or 3 molar equivalents of CaCl₂). According to some embodiments, the pH is maintained at the value equal to or above 8, equal to or above 9, equal to or above 10, equal to or above 11, or equal to or above 12 during the whole process of preparation. According to some embodiments, the pH is maintained at a value between 8 and 13 during the whole process of preparation.

In some examples, the present invention provides a method comprising the steps of:
(i) dissolving a base and sodium tripolyphosphate as a stabilizer in an aqueous solution, wherein the pH of the resulting aqueous solution is 8 or more;
(ii) bubbling or pressurizing CO₂ gas into the solution obtained in step (i) followed by adding a MgSO₄ to the solution;
(iii) optionally adding sodium tripolyphosphate as a stabilizer to the solution obtained in step (ii), and
(iv) collecting the resulting stabilized amorphous magnesium carbonate,
   wherein the base is selected from NaOH and NH₄OH and is added in the amount equal to at least 2 equivalents of MgSO₄ and optionally wherein MgSO₄ is anhydrous or heptahydrate MgSO₄. In some embodiments, the method comprises adding the stabilizer at step (iii). In some embodiments, the base is selected from NaOH or NH₄OH and is added in the amount equal to 2 or 3 molar equivalents of CaCl₂) or MgSO₄. According to some embodiments, the pH is maintained at the value equal to or above 8, equal to or above 9, equal to or above 10, equal to or above 11, or equal to or above 12 during the whole process of preparation. According to some embodiments, the pH is maintained at a value between 8 and 13 during the whole process of preparation.

In some examples, the present invention provides a method comprising the steps of:
(i) dissolving a base and sodium tripolyphosphate as a stabilizer in an aqueous solution, wherein the pH of the resulting aqueous solution is 8 or more;
(ii) adding MgSO₄ and optionally sodium tripolyphosphate as a stabilizer to the solution obtained in step (i) followed by bubbling or pressurizing CO₂ gas to the solution;
(iii) optionally adding sodium tripolyphosphate as a stabilizer to the solution obtained in step (ii), and
(iv) collecting the resulting stabilized amorphous magnesium carbonate,
   wherein the base is selected from NaOH and NH₄OH and is added in the amount equal to at least 2 equivalents of MgSO₄ and optionally wherein MgSO₄ is anhydrous or heptahydrate MgSO₄. In some embodiments, the method comprises adding the stabilizer at step (iii). In some embodiments, the base is selected from NaOH or NH₄OH and is added in the amount equal to 2 or 3 molar equivalents of MgSO₄. According to some embodiments, the pH is maintained at the value equal to or above 8, equal to or above 9, equal to or above 10, equal to or above 11, or equal to or above 12 during the whole process of preparation. According to some embodiments, the pH is maintained at a value between 8 and 13 during the whole process of preparation.

In some examples, the present invention provides a method comprising providing an aqueous solution having a pH equal to or above 8 and: (i) continuously adding to the aqueous solution a base, sodium triphosphate, and calcium chloride, (ii) continuously bubbling or pressurizing CO₂ gas into the solution, and (iii) continuously collecting the resulting amorphous calcium carbonate, wherein the base is selected from NaOH and NH₄OH and is added in the amount of at least 2 molar equivalents of calcium chloride and wherein the pH is constantly maintained equal to or above 8 during the whole process. According to some embodiments, the pH is maintained at the value equal to or above 8, equal to or above 9, equal to or above 10, equal to or above 11, or equal to or above 12 during the whole process of preparation. According to some embodiments, the pH is maintained at a value between 8 and 13 during the whole process of preparation.

In some examples, the present invention provides a method comprising comprises: providing an aqueous solution having a pH equal to or above 8 and: (i) continuously adding to the aqueous solution a base, sodium triphosphate, and magnesium sulfate, (ii) continuously bubbling or pressurizing CO₂ gas into the solution, and (iii) continuously collecting the resulting amorphous magnesium carbonate, wherein the base is selected from NaOH and NH₄OH and is added in the amount of at least 2 molar equivalents of magnesium sulfate and wherein the pH is constantly maintained equal to or above 8 during the whole process. According to some embodiments, the pH is maintained at the value equal to or above 8, equal to or above 9, equal to or above 10, equal to or above 11, or equal to or above 12 during the whole process of preparation. According to some embodiments, the pH is maintained at a value between 8 and 13 during the whole process of preparation.

According to another aspect, the present invention provides a stabilized amorphous alkaline earth metal carbonate prepared by a method according to any one of the above examples. According to some examples, the present invention provides a stabilized amorphous calcium carbonate prepared by a method according to any one of the above examples. According to some examples, the present invention provides a stabilized amorphous magnesium carbonate prepared by a method according to any one of the above examples. According to some embodiments, the present invention provides a stabilized amorphous alkaline earth metal carbonate obtained or obtainable by a method according to any one of the above examples. According to some embodiments, the present invention provides a stabilized amorphous carbonate obtained or obtainable by a method according to any one of the above examples. According to another aspect, the present invention provides a use of the stabilized ACC according prepared by the methods of the present invention in agriculture and in veterinary.

### DETAILED DESCRIPTION OF THE INVENTION

According to one aspect, the present invention provides a method of preparing a stabilized alkaline earth metal carbonate, the method comprising:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; or
   adding a salt of an alkaline earth metal into the solution obtained in step (i) followed by bubbling or pressurizing CO₂ gas into the solution,
   thereby precipitating an amorphous alkaline earth metal carbonate, and
(iii) collecting the resulting stabilized amorphous alkaline earth metal carbonate precipitate,
   wherein the method comprises adding at least one stabilizer in at least one stage during the preparation process. Non-limiting examples of stages are: (a) before bubbling or pressurizing CO₂ gas; (b) after bubbling or pressurizing CO₂ gas; (c) before adding a salt of an alkaline earth metal, (d) together with adding a salt of an alkaline earth metal or (e) after adding a salt of an alkaline earth metal.

Therefore, according to some embodiments, the present invention provides a method of preparing a stabilized amorphous alkaline earth metal carbonate, the method comprising:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; or
   adding a salt of an alkaline earth metal into the solution obtained in step (i) followed by bubbling or pressurizing CO₂ gas into the solution,
   thereby precipitating the amorphous alkaline earth metal carbonate, and
(iii) collecting the resulting amorphous alkaline earth metal carbonate precipitate,
   wherein the method comprises adding at least one stabilizer in at least one of the following stages: (a) before bubbling or pressurizing CO₂ gas; (b) after bubbling or pressurizing CO₂ gas; (c) before adding a salt of an alkaline earth metal, (d) together with adding a salt of an alkaline earth metal or (e) after adding a salt of an alkaline earth metal.

The term “aqueous solution” refers to a composition comprising at least 50%, at least 60%, at least 70%, at least 80%, at least 90% or 100% water. In preferred embodiments, the term “aqueous solution” refers to “water”, such as distilled water, double distilled water or any other aqueous solution as well known in the art.

According to some embodiments, the stabilizer is added before bubbling or pressurizing CO₂ gas. According to some embodiments, the stabilizer is added after bubbling or pressurizing CO₂ gas. According to some embodiments, the stabilizer is added before adding a salt of an alkaline earth metal. According to some embodiments, the stabilizer is added together with adding a salt of an alkaline earth metal e.g., by admixing the salt of an alkaline earth metal and the stabilizer together. According to some embodiments, the stabilizer is added after adding a salt of an alkaline earth metal. According to some embodiments, the stabilizer is added before bubbling or pressurizing CO₂ gas and together with adding a salt of an alkaline earth metal. According to some embodiments, the stabilizer is added before bubbling or pressurizing CO₂ gas and after adding a salt of an alkaline earth metal. According to some embodiments, the stabilizer is added after bubbling or pressurizing CO₂ gas and after adding a salt of an alkaline earth metal.

According to some embodiments, the stabilizer is added after bubbling or pressurizing CO₂ gas and together adding a salt of an alkaline earth metal.

According to some embodiments, the method comprises:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; and
(iii) collecting the resulting amorphous alkaline earth metal carbonate precipitate.

In some embodiments, the method comprises adding a stabilizer before bubbling or pressurizing CO₂ gas into the solution obtained in step (i). In some embodiments, the method comprises adding a stabilizer after adding the salt of an alkaline earth metal. In some embodiments, the method comprises adding a stabilizer before bubbling or pressurizing CO₂ gas into the solution obtained in step (i) and after adding the salt of an alkaline earth metal.

According to some embodiments, the method comprises:
(i) dissolving a base in an aqueous solution, wherein the resulting solution has a pH equal to or above 8;
(ii) adding a salt of an alkaline earth metal into the solution obtained in step (i) followed by bubbling or pressurizing CO₂ gas into the solution,
(iii) collecting the resulting amorphous alkaline earth metal carbonate precipitate.

According to some embodiments, the method comprises adding a stabilizer together with adding the salt of an alkaline earth metal. According to some embodiments, the method comprises adding a stabilizer before bubbling or pressurizing CO₂ gas into the solution obtained in step (i). According to some embodiments, the method comprises adding a stabilizer together with adding the salt of an alkaline earth metal and further before bubbling or pressurizing CO₂ gas.

According to some embodiments, the stabilizer added in several stages is the same or different. According to some embodiments, the stabilizer added before bubbling or pressurizing CO₂ gas into the solution obtained in step (i) and added after adding the salt of an alkaline earth metal is the same stabilizer. According to other embodiments, stabilizers added in different stages are different stabilizers.

According to some embodiments, the stabilizers are added together with adding the salt of an alkaline earth metal, and further before bubbling or pressurizing CO₂ gas is the same stabilizer. According to other embodiments, stabilizers added in different stages are different stabilizers.

As contemplated by the present invention, the terms “bubbling CO₂” and “pressurizing CO₂” may be used interchangeably and refer to incorporating CO₂ into an aqueous solution. The process may be performed as known in the art. The bubbling may be performed with constant pressure or with varying pressures, at a constant pace or with varying paces.

According to some embodiments, the method comprises, as a first step, dissolving a base and a stabilizer in an aqueous solution. Therefore, according to some embodiments, the present invention provides a method of preparing a stabilized amorphous alkaline earth metal carbonate, the method comprising:
(i) dissolving a base and a stabilizer in an aqueous solution, wherein the resulting solution has a pH equal to or above 8;
(ii) bubbling or pressurizing CO₂ gas into the solution obtained in step (i) followed by adding a salt of an alkaline earth metal and optionally adding a stabilizer to the solution; or adding a salt of an alkaline earth metal into the solution obtained in step (i) followed by bubbling or pressurizing CO₂ gas into the solution and optionally adding a stabilizer,
   thereby precipitating the stabilized amorphous alkaline earth metal carbonate;
(iii) optionally adding a stabilizer to the solution obtained in step (ii), and
(iv) collecting the resulting stabilized amorphous alkaline earth metal carbonate,
   wherein CO₂ is introduced into the solutions constantly during steps (ii) and (iii), if present and the stabilizer in steps (i) and in steps (ii) and/or (iii), if present, is the same or different.

According to some embodiments, step (ii) comprises bubbling or pressurizing CO₂ gas into the solution obtained in step (i) followed by adding a salt of an alkaline earth metal. Therefore, according to some embodiments, the method comprises the steps of:
(i) dissolving a base and a stabilizer in an aqueous solution;
(ii) bubbling or pressurizing CO₂ gas into the solution obtained in step (i) followed by adding a salt of an alkaline earth metal and optionally adding a stabilizer to the solution;
(iii) optionally adding a stabilizer to the solution obtained in step (ii), and
(iv) collecting the resulting stabilized amorphous alkaline earth metal carbonate.

According to another embodiment, step (ii) comprises adding a salt of an alkaline earth metal into the solution obtained in step (i) followed by bubbling or pressurizing CO₂ gas into the solution. Thus, according to some embodiments, the method comprises the steps of:
(i) dissolving a base and a stabilizer in an aqueous solution;
(ii) adding a salt of an alkaline earth metal and optionally adding a stabilizer to the solution obtained in step (i) followed by bubbling or pressurizing CO₂ gas;
(iii) optionally adding a stabilizer to the solution obtained in step (ii), and
(iv) collecting the resulting stabilized amorphous alkaline earth metal carbonate.

In some embodiments, the present invention provides a method of preparing a stabilized amorphous carbonate of an alkaline earth metal, the method comprising:
(a) dissolving a base in an aqueous solution;
(b) dissolving a stabilizer in the solution obtained in step (a) and followed by bubbling or pressurizing CO₂ gas into the solution, wherein dissolving the stabilizer and starting the CO₂ introduction by bubbling or pressurizing is performed in either order;
(c) adding a salt of an alkaline earth metal and optionally a stabilizer to the solutions obtained in step (b), thereby precipitating the ACC; and
(d) optionally adding a stabilizer to the solution obtained in step (c),
   wherein CO₂ is introduced into the solutions constantly during steps (b) and (c), and the stabilizer in steps (b), and in steps (c) and (d), if added, is the same or different.

According to some embodiments, the method of the present invention allows fixating CO₂ gas. Therefore, in any one of the embodiments of the present invention the term “method of preparing a stabilized amorphous carbonate of an alkaline earth metal” may be replaced by the term “a method of fixating CO₂”.

According to some embodiments, the present invention provides a method of fixating CO₂, the method comprising:
(a) dissolving a base in an aqueous solution;
(b) dissolving a stabilizer in the solution obtained in step (a) and followed by bubbling or pressurizing CO₂ gas into the solution, wherein dissolving the stabilizer and starting the CO₂ introduction by bubbling or pressurizing is performed in either order;
(c) adding a salt of an alkaline earth metal and optionally a stabilizer to the solutions obtained in step (b), thereby precipitating the stabilized amorphous alkaline earth metal carbonate; and
(d) optionally adding a stabilizer to the solution obtained in step (c),
   wherein CO₂ is introduced into the solutions constantly during steps (b) and (c), and the stabilizer in steps (b), and in steps (c) and (d), if added, is the same or different.

According to some embodiments, the present invention provides a method of fixating CO₂, the method comprising:
(i) dissolving a base and a stabilizer in an aqueous solution, wherein the resulting solution has a pH equal to or above 8;
(ii) bubbling or pressurizing CO₂ gas into the solution obtained in step (i) followed by adding a salt of an alkaline earth metal and optionally adding a stabilizer to the solution; or adding a salt of an alkaline earth metal into the solution obtained in step (i) followed by bubbling or pressurizing CO₂ gas into the solution and optionally adding a stabilizer,
   thereby fixating CO₂ and precipitating a stabilized alkaline earth metal carbonate;
(iii) optionally adding a stabilizer to the solution obtained in step (ii), and
(iv) collecting the resulting stabilized amorphous alkaline earth metal carbonate,
   wherein CO₂ is introduced into the solutions constantly during steps (ii) and (iii), if present and the stabilizer in steps (i) and in steps (ii) and/or (iii), if present, is the same or different.

According to some embodiments, the pH of the solution obtained after the addition of the base in step (i) is equal to or above 8, equal to or above 9, equal to or above 10, equal to or above 11, or equal to or above 12. According to some embodiments, the pH of the solution obtained in step (i) is equal to or above 9. According to some embodiments, the pH of the solution obtained in step (i) is equal to or above 10. According to some embodiments, the pH of the solution obtained in step (i) is equal to or above 11. According to some embodiments, the pH of the solution obtained in step (i) is equal to or above 12. According to some embodiments, the pH of the solution obtained in step (i) is from 8 to 13. According to some embodiments, the pH of the solution obtained in step (i) is from 9 to 13. According to some embodiments, the pH of the solution obtained in step (i) is from 10 to 13. According to some embodiments, the pH of the solution obtained in step (i) is from 1 to 13. According to some embodiments, the pH of the solution obtained in step (i) is from 8 to 12. According to some embodiments, the pH of the solution obtained in step (i) is from 9 to 12. According to some embodiments, the pH of the solution obtained in step (i) is from 10 to 12. According to some embodiments, the pH of the solution obtained in step (i) is from 9 to 11. According to some embodiments, the pH of the solution obtained in step (i) is from 10 to 12. According to some embodiments, the pH of the solution obtained in step (i) is from 9.5 to 10.5 or about 10.

According to some embodiments, the precipitation of the alkaline earth metal carbonate is accomplished within 2 minutes. According to some embodiments, the precipitation of the alkaline earth metal carbonate is accomplished within 3 minutes. According to some embodiments, the precipitation of the alkaline earth metal carbonate is accomplished within 1.5 minutes.

According to some embodiments, the method comprises adding a stabilizer at step (ii). Therefore, according to some embodiments, step (ii) comprises bubbling or pressurizing CO₂ gas into the solution obtained in step (i) followed by adding a salt of an alkaline earth metal and adding a stabilizer. According to other embodiments, step (ii) comprises adding a salt of an alkaline earth metal and a stabilizer to the solution obtained in step (i) followed by bubbling or pressurizing CO₂ gas. According to some embodiments, the stabilizer added in step (i) and step (ii) is the same stabilizer. According to some embodiments, the stabilizer added in step (i) and step (ii) are different stabilizers.

According to some embodiments, the method comprises adding a stabilizer in steps (i) and step (ii) only. According to some embodiments, the method comprises adding a stabilizer at step (iii). According to some embodiments, the method comprises adding a stabilizer in steps (i) and step (iii) only. According to some embodiments, the stabilizer added in step (i) and step (iii) is the same stabilizer. According to some embodiments, the stabilizer added in step (i) and step (iii) are different stabilizers. According to some embodiments, the method comprises adding a stabilizer in steps (ii) and step (iii). According to some embodiments, when the stabilizer is added in multiple stages or steps, the stabilizers may be different in each step. According to other embodiments, the stabilizer in all steps may be the same stabilizer.

According to any one of the above embodiments, the method may comprise a step or degassing of the aqueous solution before initiation of the process of preparation the stabilized amorphous alkaline earth metal carbonate or fixation of CO₂. The degassing may be performed using any known technique. According to some embodiments, the degassing is performed by bubbling CO₂ gas into the aqueous solution, e.g., before adding a base.

According to some embodiments, the method of the present invention is executed/performed in the form of a batch reaction. According to some embodiments, the method is executed/performed in the form of a series of batches. Therefore, according to any one of the above embodiments, the method is a batch method.

According to some embodiments, the method is executed/performed in the form of a continuous process. Therefore, according to some embodiments of the invention, the present invention provides a method of preparing a stabilized amorphous alkaline earth metal carbonate, the method comprises: providing an aqueous solution having a pH equal to or above 8 and: (i) continuously adding to the aqueous solution a base, at least one stabilizer, and an alkaline earth metal, (ii) continuously bubbling or pressurizing CO₂ gas into the solution, and (iii) continuously collecting the resulting stabilized amorphous alkaline earth metal carbonate precipitate, wherein the pH is constantly maintained equal to or above 8 during the whole process. According to some embodiments, the pH of the provided solution is equal to or above 8, equal to or above 9, equal to or above 10, equal to or above 11, or equal to or above 12 and is maintained at a value between 8 and 12 during the whole process. According to some embodiments, the pH of the provided solution is from 8 to 13 and the pH is maintained at a value between 8 and 13 during the whole process. According to some embodiments, the pH of the provided solution is from 8 to 13. According to some embodiments, the pH of the provided solution is from 9 to 13. According to some embodiments, the pH of the provided solution is from 10 to 13. According to some embodiments, the pH of the provided solution is from 1 to 13. According to some embodiments, the pH of the provided solution is from 8 to 12. According to some embodiments, the pH of the provided solution is from 9 to 12. According to some embodiments, the pH of the provided solution is from 10 to 12. According to some embodiments, the pH of the provided solution is from 9 to 11. According to some embodiments, the pH of the provided solution is from 10 to 12. According to some embodiments, the pH of the provided solution is from 9.5 to 10.5 or about 10. According to some embodiments, the pH is maintained at the value of from 8 to 13 during the whole process. According to some embodiments, the pH is maintained at the value of from 9 to 13 during the whole process. According to some embodiments, the pH is maintained at the value of from 10 to 13 during the whole process. According to some embodiments, the pH is maintained at the value of from 1 to 13 during the whole process. According to some embodiments, the pH is maintained at the value of from 8 to 12 during the whole process. According to some embodiments, the pH is maintained at the value of from 9 to 12 during the whole process. According to some embodiments, the pH is maintained at the value of from 10 to 12 during the whole process. According to some embodiments, the pH is maintained at the value of from 9 to 11 during the whole process. According to some embodiments, the pH is maintained at the value of from 10 to 12 during the whole process. According to some embodiments, the pH is maintained at the value of from 9.5 to 10.5 or about 10 during the whole process.

The term “amorphous alkaline earth metal carbonate” refers to the amorphous form of a carbonate of any alkaline earth metal. Non-limiting examples of alkaline earth metals are calcium and magnesium. The terms “amorphous alkaline earth metal carbonate” and “stabilized amorphous alkaline earth metal carbonate” are used herein interchangeably. The terms “amorphous calcium carbonate”, “ACC”, “stable ACC” and “stabilized ACC” are used herein interchangeably and refer to the amorphous form of calcium carbonate. The terms “amorphous magnesium carbonate”, “AMC”, “stable AMC” and “stabilized AMC” are used herein interchangeably and refer to the amorphous form of magnesium calcium carbonate. The term AMC does not preclude the existence of Mg—OH functional groups. The term “stable” as used herein indicates that the calcium carbonate is maintained in the amorphous form for a long period of time, for example for about at least 7 days in the solid form having less than or about 30% crystalline calcium carbonate. According to any one of the above embodiments, the composition is stable for at least 7 days. According to some embodiments, the composition is stable for at least 1 month. According to other embodiments, the composition is stable for at least 3 months. According to a further embodiment, the composition is stable for 6 months. According to certain embodiments, the composition is stable for at least 1 year. According to a particular embodiment, the composition is stable for at least 2 years. According to some embodiments, ACC is stable in amorphous form for at least 7 days, at least 1 month, at least 3 months or for 6 months in an aqueous solution.

In most cases, the resulting ACC or AMC contains from 1 to 20 wt % of adsorbed water and maintains its stabilization in the presence of a stabilizer and further storage in dry conditions. According to some embodiments, the resulting ACC comprises from 5 to 15 wt % or about 10 wt % of adsorbed water. As can be seen from the Examples, the ACC powder that was obtained in the examples contained about 6 to 10 wt % of water when formulated. In terms of calcium content, it means that the calcium content in ACC is in a practical range of 28 to 38 wt % of its composition. According to some embodiments, the resulting stabilized ACC comprises from 30 to 38 wt %, from 32 to 36 or about 34 wt % of calcium.

A slight amount of precursors to water also exist in the form of bicarbonate [Ca—O—(C═O)—OH] and carbonate anions [Ca—O—(C═O)—O⁻] found in the disorganized molecular network of the ACC. At elevated temperature and as a part of the crystallization process, these species are converted to fully bonded carbonates by a condensation reaction, which lead to the release of water molecules.

In the case of amorphous magnesium carbonate, one can expect even a more complex presence of water and precursors to water, since it is well known that even the molecular structure of most of the 8 defined phases of crystalline magnesium carbonate are “hydrates” (i.e., containing water molecules, which are complexed by strong bonding to the Mg element), “basic” (i.e., containing Mg—OH), or both. In addition, the presence of various bicarbonate species has been detected in crystallized magnesium carbonate phases, e.g., the most common nesquehonite phase, previously defined as MgCO₃·3H₂O.

According to some embodiments, the salt of an alkaline earth metal is a water-soluble salt of an alkaline earth metal. According to some embodiments, the salt of an alkaline earth metal is selected from a halide, nitrate and sulfate salt of the metal and hydrates thereof. According to some embodiment, the alkaline earth metal is selected from calcium and magnesium. According to some embodiments, the salt of an alkaline earth metal is selected from calcium halide, magnesium halide, calcium nitrate, magnesium nitrate, and magnesium sulfate. According to some embodiment, the halide is selected from chlorine and bromide. According to some embodiments, the alkaline earth metal salt is selected from calcium chloride, calcium bromide, calcium nitrate, magnesium chloride, magnesium sulfate magnesium nitrate and a combination thereof. According to some embodiments, the alkaline earth metal salt is calcium chloride. According to some embodiments, the alkaline earth metal salt is calcium sulfate. According to some embodiments, the alkaline earth metal salt is magnesium chloride. According to some embodiments, the alkaline earth metal salt is magnesium sulfate. According to some embodiments, the alkaline earth metal salt may be water-insoluble such as CaO, Ca(OH)₂, MgO, Mg(OH)₂. In another embodiment, the alkaline earth metal salt a combination of calcium chloride and magnesium sulfate.

According to some embodiments, the alkaline earth metal salt is calcium chloride. According to some embodiments, the calcium chloride may be of any known hydration state i.e., CaCl₂·nH₂O, for various values of n=0, 1, 2, 4 or 6, e.g., anhydrous, monohydrate or dihydrate. According to some embodiments, calcium chloride is calcium chloride hydrate.

According to some embodiments, the alkaline earth metal salt is magnesium sulfate. According to some embodiments, the magnesium sulfate may be of any known hydration state. Magnesium sulfate may be in a form of hydrate MgSO₄·nH₂O, for various values of n between 1 and 11. According to some embodiments, magnesium sulfate may be in a form of anhydrous or heptahydrate. According to some embodiments, magnesium sulfate is magnesium sulfate heptahydrate.

According to some embodiments, the method comprises adding from 0.02 to 1 molar (M) of the alkaline earth metal salt. According to some embodiments, the method comprises adding from 0.02 to 0.95 M of the alkaline earth metal salt. According to some embodiments, the method comprises adding from 0.03 to 0.9 M of the alkaline earth metal salt. According to some embodiments, the method comprises adding from 0.06 to 0.86 M of the alkaline earth metal salt. According to some embodiments, the method comprises adding from 0.1 to 0.85 M of the alkaline earth metal salt. According to some embodiments, the method comprises adding from 0.15 to 0.85 M of the alkaline earth metal salt. According to some embodiments, the method comprises adding from 0.2 to 0.85 M of the alkaline earth metal salt. According to some embodiments, the method comprises adding from 0.25 to 0.85 M of the alkaline earth metal salt. According to some embodiments, the method comprises adding from 0.3 to 0.80 M of the alkaline earth metal salt. According to some embodiments, the method comprises adding from 0.34 to 0.85 M of the alkaline earth metal salt. According to some embodiments, the method comprises adding from 0.2 to 0.6 M of the alkaline earth metal salt. According to some embodiments, the method comprises adding from 0.3 to 0.5 M of the alkaline earth metal salt. According to some embodiments, the method comprises adding from 0.3 to 0.4 M of the alkaline earth metal salt. According to some embodiments, the alkaline earth metal salt is calcium chloride. According to some embodiments, the alkaline earth metal salt is magnesium sulfate.

According to some embodiments, the method comprises adding from 0.1 to 0.85 M of calcium chloride. According to some embodiments, the method comprises adding from 0.2 to 0.85 M of calcium chloride. According to some embodiments, the method comprises adding from 0.3 to 0.8 M of calcium chloride. According to some embodiments, the method comprises adding from 0.3 to 0.7 M of calcium chloride. According to some embodiments, the method comprises adding from 0.3 to 0.6 M of calcium chloride. According to some embodiments, the method comprises adding from 0.3 to 0.5 M of calcium chloride. According to some embodiments, the method comprises adding about 0.34M of calcium chloride. According to some embodiments, the calcium chloride may be of any known hydration state, e.g., anhydrous, monohydrate or dihydrate.

According to some embodiments, the method comprises adding from 0.1 to 0.85 M of magnesium sulfate. According to some embodiments, the method comprises adding from 0.2 to 1 M of magnesium sulfate. According to some embodiments, the method comprises adding from 0.3 to 0.9 M of magnesium sulfate. According to some embodiments, the method comprises adding from 0.35 to 0.8 M of magnesium sulfate. According to some embodiments, the method comprises adding from 0.4 to 0.6 M of magnesium sulfate. According to some embodiments, the method comprises adding from 0.4 to 0.5 M of magnesium sulfate. According to some embodiments, the method comprises adding about 0.46M of magnesium sulfate. According to some embodiments, magnesium sulfate may be in the form of anhydrous or heptahydrate. According to some embodiments, magnesium sulfate is magnesium sulfate heptahydrate.

According to any one of the above embodiments, when referring to a continuous method of preparing the amorphous stabilized amorphous alkaline earth metal carbonate, the term “adding a compound at a concentration X” or any equivalents of this phrase contemplates a continuous adding and maintaining the stated concentration.

According to some embodiments, the base is selected from a hydroxide of an alkali metal, ammonia or ammonium hydroxide. According to some embodiment, the base is a hydroxide of an alkali metal. According to some embodiments, the alkali metal is selected from sodium and potassium. According to one embodiment, the hydroxide of an alkali metal is sodium hydroxide (NaOH). According to one embodiment, the base is ammonia. According to one embodiment, the base is ammonium hydroxide.

According to some embodiments, the amount of the base added in step (i) corresponds to at least 2 molar equivalents of the amount of the alkaline earth metal salt. According to some embodiments, the amount of the base added in step (i) corresponds to at least 3 molar equivalents of the amount of the alkaline earth metal salt. According to some embodiments, the amount of the base, such as NaOH, ammonia or ammonium hydroxide corresponds to at least 2 or at least 3 molar equivalents of the alkaline earth metal added to the reaction. According to some embodiments, the concentration of base, e.g., NaOH or ammonium hydroxide is 2, 2.5, 3, 3.5, 4, 4.5 or 5 molar equivalents of the alkaline earth metal added to the reaction. According to some embodiments, the concentration of the base of from 2 to 5 molar equivalents of the alkaline earth metal is maintained constantly by constantly adding the base to the reaction mixture.

According to some embodiments, the amount/concentration of NaOH added in step (i) corresponds to at least 2 or at least 3 molar equivalents of CaCl₂) added. According to some embodiments, the amount/concentration of NH₄OH added in step (i) corresponds to at least 2 or at least 3 molar equivalents of CaCl₂) added.

According to some embodiments, the amount/concentration of NaOH in step (i) corresponds to at least 2 or at least 3 molar equivalents of MgSO₄ added. According to some embodiments, the amount/concentration of NH₄OH in step (i) corresponds to at least 2 or at least 3 molar equivalents of MgSO₄ added. According to some embodiments, the base is added continuously or fractionally throughout the process via solid, solution or gas phase. According to some embodiments, the concentration of the base, e.g., NaOH or NH₄OH is kept constant and corresponds to at least 2 molar equivalents of the alkaline earth metal salt, e.g., CaCl₂) of MgSO₄.

According to any one of the above embodiments, the ACC is stabilized by at least one stabilizer. The terms “stabilizing agent” and “stabilizer” are used herein interchangeably and refer to any molecule, ion or substance that contributes to preserving calcium carbonate in the amorphous state during ACC production, formulating and/or storage. According to the teachings of the present invention, the ACC acts as an active agent conferring improvement in athletic and muscle performance. Any ACC that remains stable may be used according to the teaching of the present invention. Any compound that may stabilize ACC in its amorphous form is suitable for the implementation of the present invention.

### ACC Stabilizers

The stabilizer may comprise a molecule having one or more functional groups selected from, but not limited to, hydroxyl, carboxyl, ester, amine, phosphino, phosphono, phosphate, sulfonyl, sulfate or sulfino groups. The hydroxy bearing compounds, combined with the hydroxide, optionally also bear other functions like carboxyl, etc. but with the hydroxyl not being esterified.

According to some embodiments, the stabilizer has low toxicity or no toxicity to mammalian cells or organism, and in particular to a human being. According to some embodiment, the stabilizer is of food, nutraceutical or pharmaceutical grade.

In certain embodiments, the ACC stabilizing agent is independently at each occurrence, an organic acid, phosphorylated, phosphonated, sulfated or sulfonated organic compound, phosphoric or sulfuric ester of a hydroxyl carboxylic acid, an organoamine compound, an organic compound comprising a hydroxyl, an organophosphorous compound or salts thereof, phosphorylated amino acids and derivatives thereof, a bisphosphonate compound, an organophosphate compound, an organophosphonate compound, an inorganic phosphorous acid, an organic compound having multiple functional groups as defined above, an inorganic phosphate and polyphosphate compound, an organic compound having a polyphosphate chain, an organic surfactant, a bio-essential inorganic ion, salts thereof or any combination thereof.

According to some embodiments, the stabilizer is an organic acid or salt thereof. According to certain embodiments, the organic acid is selected from ascorbic acid, citric acid, lactic acid, acetic acid, oxalic acid, malonic acid, glutaconic acid, succinic acid, maleic acid, lactic acid, aconitic acid, or salts thereof and optionally include compounds having at least two carboxylic groups and molecular weight not larger than 250 g/mol, such as citric acid, tartaric acid, malic acid, etc. According to one particular embodiment, the stabilizer is citric acid or a citrate salt

In another embodiment, the phosphoric ester of hydroxyl carboxylic acids is a phosphoenolpyruvate. In another embodiment, the phosphoric or sulfuric esters of hydroxyl carboxylic acids comprise amino acids. Examples of such esters are phosphoserine, phosphothreonine, sulfoserine, sulfothreonine and phosphocreatine.

The hydroxyl bearing compounds combined with hydroxide may comprise, for example, mono-, di- tri-, oligo-, and polysaccharides like sucrose or other polyols like glycerol. The hydroxyl bearing compounds may further comprise hydroxy acids like citric acid, tartaric acid, malic acid, etc., or hydroxyl-bearing amino acids such as serine or threonine and salts thereof. Each possibility represents a separate embodiment, of the present invention.

Some specific unlimited examples for such ACC stabilizers that include phytic acid, citric acid, and salts thereof, sodium pyrophosphate dibasic, adenosine 5′-monophosphate (AMP) sodium salt, adenosine 5′-diphosphate (ADP) sodium salt and adenosine 5′-triphosphate (ATP) disodium salt hydrate, phosphoserine, phosphorylated amino acids, food grade surfactants, sodium stearoyl lactylate, and combinations thereof.

According to some embodiments, the stabilizer comprises at least one component selected from phosphoric or sulfuric esters of hydroxyl carboxylic acids, such as phosphoenolpyruvate, phosphoserine, phosphothreonine, sulfoserine or sulfothreonine and hydroxyl bearing organic compounds, selected from mono-, di-, tri-, oligo- and poly-saccharides, for example, sucrose, mannose, glucose.

The hydroxyl bearing compound may further comprise at least one alkali hydroxide, such as sodium hydroxide, potassium hydroxide and the like. The phosphorylated acids may be present in oligopeptides and polypeptides. In other embodiments, of the invention, the stabilizer is an organic acid selected from monocarboxylic acid or multiple carboxylic acid, e.g., dicarboxylic acid or tricarboxylic acid. Each possibility represents a separate embodiment of the invention. The organic acid may be as defined above.

In some embodiments of the invention, the ACC stabilizer is selected from phosphorylated amino acids, polyols and combinations thereof. In some embodiments, the stable ACC comprises a phosphorylated compound as a stabilizer wherein the phosphorylation is performed on the hydroxyl group of an organic compound. In some embodiments, the stable ACC comprises a stabilizer selected from the group consisting of citric acid, phosphoserine, phosphothreonine and combinations thereof. The non-limiting examples of stabilizers containing phosphate, phosphite, phosphonate groups and salts or esters thereof include phytic acid, dimethyl phosphate, trimethyl phosphate, sodium pyrophosphate, tetraethyl pyrophosphate, ribulose bisphosphate, etidronic acid and other medical bisphosphonates, 3-phosphoglyceric acid salt, glyceraldehyde 3-phosphate, 1-deoxy-D-xylulose-5-phosphate sodium salt, diethylene triamine pentakis(methylphosphonic acid), nitrilotri(methylphosphonic acid), 5-phospho-D-ribose 1-diphosphate pentasodium salt, adenosine 5′-diphosphate sodium salt, adenosine 5′-triphosphate disodium salt hydrate, α-D-galactosamine 1-phosphate, 2-phospho-L-ascorbic acid trisodium salt, α-D-galactose 1-phosphate dipotassium salt pentahydrate, α-D-galactosamine 1-phosphate, O-phosphorylethanolamine, disodium salt hydrate, 2,3-diphospho-D-glyceric acid pentasodium salt, phospho(enol)pyruvic acid monosodium salt hydrate, D-glyceraldehyde 3-phosphate, sn-glycerol 3-phosphate lithium salt, D-(−)-3-phosphoglyceric acid disodium salt, D-glucose 6-phosphate sodium salt, phosphatidic acid, ibandronate sodium salt, phosphonoacetic acid, DL-2-amino-3-phosphonopropionic acid or combinations thereof.

In some embodiments, the stabilizers can be bio-essential inorganic ions including, inter alia, Na, K, Mg, Zn, Fe, P, S, N, P, or S in the phase of oxides, or N as ammonia or nitro groups.

The stabilized ACC may be stabilized by more than one stabilizer, e.g., 2, 3, or more stabilizers. The stabilizers can be added during the synthesis and precipitation of the ACC primary particles and they are defined as “internal stabilizer”. Stabilizers can be added after the synthesis and bind to the external surface of the particles. They are defined as “external stabilizers”. In some embodiments, where both internal and external stabilizers are used the internal stabilizer and the external stabilizer are similar. In other embodiments, the internal stabilizer and the external stabilizer are different stabilizers. The internal and the external stabilizers may be each independently as defined hereinabove and each can be a combination of more than one type of stabilizer.

The stable ACC can comprise more than two stabilizers, wherein one or more stabilizers are added to the ACC during the formation and precipitation of the ACC.

According to some embodiments, the stabilizer is selected from the group consisting of a polyphosphate, polyphosphonate, bisphosphonate, phosphorylated amino acid, citric acid, salts thereof and any combination thereof. In some embodiments, more than one stabilizer, e.g., 2, 3, or 4 stabilizers are added.

According to one embodiment, ACC is stabilized by a combination of phosphoserine and citric acid. According to another embodiment, ACC is stabilized by a combination of triphosphate and citric acid.

According to some embodiments, the stabilizer is a polyphosphate or pharmaceutically acceptable salts thereof. According to some embodiments, the polyphosphate is physiologically compatible, water-soluble polyphosphate salt selected from the group consisting of sodium, potassium, and any other essential cation of polyphosphate. In one embodiment, the polyphosphate is organic or inorganic polyphosphate. The term “polyphosphate” as used herein refers to (1) polymeric unhydrates of PO₄ or a (2) phosphorylated organic compound containing more than 1 phosphorylated groups via C—O—P (ether) bonding An example for Type 2 polyphosphate is phytic acid or salts thereof, which contains 6-phosphorylated groups. According to some embodiments, the polyphosphate is a physiologically compatible water-soluble polyphosphate salt selected from the group consisting of sodium and potassium polyphosphate. In some embodiments, the polyphosphate is an inorganic polyphosphate or pharmaceutically acceptable salts thereof. Not-limiting examples of such salt are Na, K, Mg, Mn, and Zn. According to some embodiments, the polyphosphate such as an inorganic polyphosphate comprises 2 to 10 phosphate groups, e.g., 2, 3, 4, 5, 6, 7, 8, 9, or 10 phosphate groups. According to some embodiments, the inorganic polyphosphate is selected from pyrophosphate, triphosphate, and hexametaphosphate. According to one embodiment, the stabilizer is pyrophosphate or pharmaceutically acceptable salts thereof such as sodium pyrophosphate. According to another embodiment, the stabilizer is triphosphate (tripolyphosphate) or pharmaceutically acceptable salts thereof such as sodium triphosphate. The term “triphosphate” and “tripolyphosphate” are used herein interchangeably. According to a further embodiment, the stabilizer is hexametaphosphate or a pharmaceutically acceptable salt thereof such as sodium hexametaphosphate.

According to some embodiments, the stabilizer is a polyphosphonate such as bisphosphonate or tetraphosphonate or pharmaceutically acceptable salts thereof. The non-limiting examples of salt are Na, K, Mg, Mn and Zn.

The term “bisphosphonate” as used herein refers to organic compounds having two phosphonate (PO(OH)₂) groups. The term further relates to compounds having a backbone of PO₃-organic-PO₃. Most typical is a series of bisphosphonates that are used as pharmaceuticals for treating osteoporosis. According to some embodiments, the bisphosphonate is selected from the group consisting of etidronic acid, zoledronic acid, medronic acid, alendronic acid, and a pharmaceutically acceptable salt thereof. According to some embodiments, the stabilizer is an etidronic acid or a pharmaceutically acceptable salt thereof. According to another embodiment, the stabilizer is a zoledronic acid or a pharmaceutically acceptable salt thereof. According to a further embodiment, the stabilizer is a medronic acid or a pharmaceutically acceptable salt thereof. According to certain embodiments, the stabilizer is alendronic acid or a pharmaceutically acceptable salt thereof.

According to certain embodiments, the stabilizer is a phosphorylated amino acid. According to one embodiment, the phosphorylated amino acid is phosphoserine. According to another embodiment, the phosphorylated amino acid is phosphothreonine.

According to certain embodiments, the stabilizer is phytic acid or salts thereof.

According to some embodiments, the ACC composition comprises a combination of the stabilizers disclosed above.

According to some embodiments, the stabilizer is an inorganic polyphosphate or a bisphosphonate as defined hereinabove, and the molar ratio between P atoms of the stabilizer and Ca atoms of the ACC (P:Ca molar ratio) is about 1:90 to 1:1. In one embodiment, the P:Ca molar ratio is about 1:40 to about 1:1. In a further embodiment, the P:Ca molar ratio is about 1:35 to about 1:2. In certain embodiments, the P:Ca molar ratio is about 1:30 to about 1:3. In certain embodiments, the P:Ca molar ratio is about 1:28 to about 1:3. In other embodiments, the P:Ca molar ratio is about 1:25 to about 1:4. In further embodiment, the P:Ca molar ratio is about 1:20 to about 1:5. In another embodiment, the P:Ca molar ratio is about 1:20 to about 1:6. In a particular embodiment, the P:Ca molar ratio is about 1:15 to about 1:5. In another particular embodiment, the P:Ca molar ratio is about 1:25 to about 1:5. According to some embodiments, such inorganic polyphosphate is pyrophosphate, triphosphate, hexametaphosphate or a pharmaceutically acceptable salt thereof. According to another embodiment, the bisphosphonate is alendronic acid, etidronic acid, zoledronic acid or medronic acid and the P:Ca molar ratio is as defined hereinabove.

According to some embodiments, the calcium content (Ca content) of such compositions comprising stabilizers is about 1 wt % to about 39 wt %, about 5 wt % to about 39 wt %, about 10% to about 39 wt %, about 15% to about 39 wt %, about 20 wt % to about 38 wt %, about 25 wt % to about 38 wt %, or about 30 wt % to about 38 wt % of the dry ACC particles The terms “Ca content” and “calcium content” is used herein interchangeably and refer to the content of calcium of the ACC in the final composition.

In certain embodiments, the P:Ca molar ratio is about 1:40 to about 1:1, and the Ca content is about 20 wt % to about 39 wt %. In some embodiments, the molar ratio is 1:28 to about 1:3, and the Ca content is about 30 wt % to about 38 wt % of the dry ACC particles. In another embodiment, the molar ratio is 1:25 to about 1:5, and the Ca content is about 30 wt % to about 36 wt % of the dry ACC particles.

According to some embodiments, the stabilizer is an inorganic polyphosphate or a bisphosphonate as defined hereinabove, and the molar ratio between P atoms of the stabilizer and Mg atoms of amorphous magnesium carbonate (AMC) (P:Mg molar ratio) is about 1:90 to 1:1. In one embodiment, the P:Mg molar ratio is about 1:40 to about 1:1. In a further embodiment, the P:Mg molar ratio is about 1:35 to about 1:2. In certain embodiments, the P:Mg molar ratio is about 1:30 to about 1:3. In certain embodiments, the P:Mg molar ratio is about 1:28 to about 1:3. In other embodiments, the P:Mg molar ratio is about 1:25 to about 1:4. In further embodiment, the P:Mg molar ratio is about 1:20 to about 1:5. In another embodiment, the P:Mg molar ratio is about 1:20 to about 1:6. In a particular embodiment, the P:Mg molar ratio is about 1:15 to about 1:5. In another particular embodiment, the P:Mg molar ratio is about 1:25 to about 1:5. According to some embodiments, such inorganic polyphosphate is pyrophosphate, triphosphate, hexametaphosphate or a pharmaceutically acceptable salt thereof. According to another embodiment, the bisphosphonate is alendronic acid, etidronic acid, zoledronic acid or medronic acid and the P:Mg molar ratio is as defined hereinabove.

According to some embodiments, the magnesium content (Mg content) of such compositions comprising stabilizers is about 1 wt % to about 39 wt %, about 5 wt % to about 39 wt %, about 10% to about 39 wt %, about 15% to about 39 wt %, about 20 wt % to about 38 wt %, about 25 wt % to about 38 wt %, or about 30 wt % to about 38 wt % of the dry ACC particles The terms “Mg content” and “magnesium content” is used herein interchangeably and refer to the content of magnesium of the AMC in the final composition.

In certain embodiments, the P:Mg molar ratio is about 1:40 to about 1:1, and the Ca content is about 20 wt % to about 39 wt %. In some embodiments, the molar ratio is 1:28 to about 1:3, and the Mg content is about 30 wt % to about 38 wt % of the dry ACC particles. In another embodiment, the molar ratio is 1:25 to about 1:5, and the Mg content is about 30 wt % to about 36 wt % of the dry AMC particles.

According to some embodiments, the stabilized ACC or AMC powder comprises absorbed and adsorbed water, from about 1 wt % to about 18 wt %, from about 4 wt % to about 15 wt %, and from about 6 wt % to about 10 wt %. According to some embodiments, the stabilizer is polyphosphate or bisphosphonate and the molar ratio between P atoms of the stabilizer and Ca atoms of the ACC is about 1:90 to 1:1. According to some embodiments, the stabilizer is polyphosphate or bisphosphonate and the molar ratio between P atoms of the stabilizer and Mg atoms of the AMC is about 1:90 to 1:1.

According to some embodiments, the stabilizer is selected from the group consisting of a polyphosphate, phosphorylated amino acid, bisphosphonate, citric acid, tartaric acid and any combination thereof. According to one embodiment, the polyphosphate is selected from the group consisting of triphosphate, pyrophosphate, and hexametaphosphate, the phosphorylated amino acid is phosphoserine or phosphothreonine, and the bisphosphonate is selected from the group consisting of alendronate, etidronic acid, zoledronic acid and medronic acid. According to some embodiments, the polyphosphate is an inorganic polyphosphate.

According to one embodiment, the stabilizer is selected from the group consisting of organic acids, phosphorylated, phosphonated, sulfated or sulfonated organic compound, phosphoric or sulfuric esters of hydroxy carboxylic acids, phosphorylated amino acids, bisphosphonate, organic polyphosphate, hydroxyl bearing organic compounds, derivatives thereof, proteins and any combinations thereof.

According to another embodiment, the stabilizer is selected from the group consisting of phosphoserine, adenosine triphosphate, adenosine diphosphate, phytic acid, citric acid, etidronic acid, pyrophosphate, polyphosphate, inorganic triphosphate, hexamethaphosphate, ethanol, and any combination thereof.

According to some embodiments, the wherein the stabilizer is selected from the group consisting of polyphosphates, organic acids, phosphorylated amino acids, phosphorylated, phosphonated, sulfated or sulfonated organic compounds, phosphoric or sulfuric esters of hydroxy carboxylic acids, bisphosphonates, organic polyphosphates, polyphosphates, hydroxyl bearing organic compounds, derivatives thereof, proteins and any combinations thereof.

According to some embodiments, wherein the stabilizer is selected from the group consisting of tripolyphosphate or a salt thereof, phosphoserine, citric acid, sodium triphosphate and citric acid, adenosine triphosphate, adenosine diphosphate, phytic acid, etidronic acid, pyrophosphate, polyphosphate, hexamethaphosphate, a salt thereof, ethanol, and any combination thereof.

According to some embodiments, the stabilizer in step (ii) and in step (iv) is sodium tripolyphosphate.

According to some embodiments, the stabilizer is added at any one of the following stages: (a) before bubbling or pressurizing CO₂ gas; (a) after bubbling or pressurizing CO₂ gas; (c) before adding a salt of an alkaline earth metal, (d) together with adding a salt of an alkaline earth metal or (e) after adding a salt of an alkaline earth metal, is sodium tripolyphosphate.

According to some embodiments, the total amount/concentration of the stabilizer is collectively from 2 to 15 wt % of the amount/concentration of the halide of an alkaline earth metal. Considering that a stabilizer may be added in more than one step, the amount/concentration of the stabilizer refers to the total amount/concentration added. It is clear that in embodiments referring to a concentration of salt of an alkaline earth metal, the corresponding units of concentration are used with respect to the stabilizer. According to some embodiments, the amount/concentration of the stabilizer is collectively from 3 to 13 wt % of the amount/concentration of the halide of an alkaline earth metal. According to some embodiments, the amount/concentration of the stabilizer is collectively from 4 to 15 wt % of the amount/concentration of the halide of an alkaline earth metal. According to some embodiments, the amount/concentration of the stabilizer is collectively from 5 to 12 wt % of the amount/concentration of the halide of an alkaline earth metal. According to some embodiments, the amount/concentration of the stabilizer is collectively from 8 to 15 wt % of the amount/concentration of the halide of an alkaline earth metal. According to some embodiments, the total concentration of sodium tripolyhosphate added collectively in all steps is from 2 to 15 wt % of the CaCl₂) added. According to some embodiments, the total concentration of sodium tripolyhosphate added collectively in all steps is from 2 to 15 wt % of the MgCl₂ added. According to some embodiments, the total concentration of sodium tripolyhosphate added collectively in all steps is from 2 to 15 wt % of the MgSO₄ added. According to some embodiments, in a continuous method of the present invention, the stabilizer is added constantly to maintain the concentration of from 2 to 15 wt % of the alkaline earth metal salt.

According to some embodiments, the method of the present invention is executed/performed at atmospheric pressure.

According to some embodiments, the method is of the present invention executed/performed under CO₂ pressure from 1 to 60 bars.

According to any one of the above embodiments, the method is performed at ambient temperature. According to some embodiments, the method is performed at the temperature of from 15 to 60° C.

According to any one of the above embodiments, the term collecting the resulting stabilized amorphous alkaline earth metal carbonate encompasses any method of collecting, e.g., continuous collecting a precipitant. According to any one of the above embodiments, collecting the resulting stabilized amorphous alkaline earth metal carbonate may be performed by filtering the precipitant of the stabilized amorphous alkaline earth metal carbonate or by any other method common in e.g., continuously collecting a solid precipitant. According to some embodiments, the method comprises filtering the resulting alkaline earth metal carbonate, e.g., ACC or AMC. According to some embodiments, the method further comprises washing the resulting ACC or AMC.

According to some embodiments, collecting further comprises drying the collected precipitant. The drying may be performed by any method, e.g., by air, fan, vacuum, oven, microwave oven, and combinations thereof or any other known method.

According to some embodiments, the present invention provides a method of preparing a stabilized amorphous alkaline earth metal carbonate or a method of fixating CO₂, the method comprising:
(i) dissolving a NaOH or NH₄OH in an aqueous solution to obtain pH 10 or more;
(ii) dissolving sodium tripolyphosphate in the solution obtained in step (i) and start bubbling or pressurizing CO₂ gas into the solution of step (i);
(iii) adding an alkaline earth metal salt to the solutions of step (ii), thereby precipitating the amorphous alkaline earth metal carbonate;
(iv) adding sodium tripolyphosphate to the solution of step (iii), and
(v) collecting the resulting amorphous stabilized alkaline earth metal carbonate,
   wherein CO₂ is introduced into the solutions constantly during steps (ii) and (iii), and
   wherein NaOH or NH₄OH is added in the amount equal to 2 or more molar equivalents of added alkaline earth metal carbonate salt. According to one embodiment, the alkaline earth metal carbonate salt is CaCl₂). According to one embodiment, the alkaline earth metal carbonate salt is MgSO₄. According to some embodiments, CaCl₂) is added to the concentration of 0.2 to 0.6M. According to some embodiments, MgSO₄ is added to the concentration of 0.3 to 0.9M. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the resulting stabilized ACC or AMC. According to some embodiments, the filtering is performed within 2 minutes from the addition of CaCl₂) or MgSO₄. According to some embodiments, the method further comprises washing the stabilized ACC or AMC.

According to some embodiments, the present invention provides a method of preparing an alkaline earth metal carbonate salt or a method of fixating CO₂, the method comprising:
(i) dissolving a NaOH or NH₄OH in an aqueous solution to obtain pH 10 or more;
(ii) dissolving sodium tripolyphosphate in the solution of step (i) and start bubbling or pressurizing CO₂ into the solution;
(iii) adding an alkaline earth metal salt and tripolyphosphate to the solutions of step (ii), thereby precipitating the amorphous alkaline earth metal carbonate;
   wherein CO₂ is introduced into the solutions constantly during steps (ii) and (iii), and
   wherein NaOH or NH₄OH is added in the amount equal to 2 or more molar equivalents of added stabilized alkaline earth metal salt. According to one embodiment, the alkaline earth metal carbonate salt is CaCl₂). According to one embodiment, the alkaline earth metal carbonate salt is MgSO₄. According to some embodiments, CaCl₂) is added to the concentration of 0.2 to 0.6M. According to some embodiments, MgSO₄ is added to the concentration of 0.3 to 0.9M. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the stabilized ACC. According to some embodiments, the filtering is performed within 2 minutes from addition of CaCl₂) or MgSO₄. According to some embodiments, the method further comprises washing the stabilized ACC or AMC.

According to some embodiments, the method of the present invention comprises the steps of:
(i) dissolving a base and sodium tripolyphosphate as a stabilizer in an aqueous solution, wherein the pH of the resulting aqueous solution is 8 or more;
(ii) bubbling or pressurizing CO₂ gas into the solution obtained in step (i) followed by adding CaCl₂) and optionally adding sodium tripolyphosphate as a stabilizer to the solution;
(iii) optionally adding sodium tripolyphosphate as a stabilizer to the solution obtained in step (ii), and
(iv) collecting the resulting stabilized amorphous calcium carbonate,
   wherein the base is selected from NaOH and NH₄OH and is added in the amount equal to at least 2 equivalents of CaCl₂) and optionally wherein CaCl₂) is selected from anhydrous, monohydrate to dihydrate. According to some embodiments, the method comprises adding a stabilizer at step (ii). According to some embodiments, the method comprises adding a stabilizer at step (iii). According to some embodiments, the method comprises adding a stabilizer at steps (ii) and (iii). According to some embodiments, the pH is maintained at the value equal to or above 8, equal to or above 9, equal to or above 10, equal to or above 11, or equal to or above 12 during the whole process of preparation. According to some embodiments, the pH is maintained at the value of from 8 to 12 during the whole process of preparation. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the stabilized ACC. According to some embodiments, the filtering is performed within 2 minutes from the addition of CaCl₂). According to some embodiments, the method further comprises washing the stabilized ACC. According to some embodiments, the method further comprises drying the stabilized ACC.

According to some embodiments, the method of the present invention comprises the steps of:
(i) dissolving a base and sodium tripolyphosphate as a stabilizer in an aqueous solution, wherein the pH of the resulting aqueous solution is 8 or more;
(ii) adding CaCl₂) and optionally sodium tripolyphosphate as a stabilizer to the solution obtained in step (i) followed by bubbling or pressurizing CO₂ gas;
(iii) optionally adding sodium tripolyphosphate as a stabilizer to the solution obtained in step (ii), and
(iv) collecting the resulting amorphous calcium carbonate,
   wherein the base is selected from NaOH and NH₄OH and is added in the amount equal to at least 2 equivalents of CaCl₂) and optionally wherein CaCl₂) is selected from anhydrous, monohydrate to dihydrate. According to some embodiments, the method comprises adding a stabilizer at step (ii). According to some embodiments, the method comprises adding a stabilizer at step (iii). According to some embodiments, the method comprises adding a stabilizer at steps (ii) and (iii). According to some embodiments, the pH is maintained at the value equal to or above 8, equal to or above 9, equal to or above 10, equal to or above 11, or equal to or above 12 during the whole process of preparation. According to some embodiments, the pH is maintained at the value of from 8 to 12 during the whole process of preparation. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the stabilized ACC. According to some embodiments, the filtering is performed within 2 minutes from the addition of initiation of CO₂ bubbling. According to some embodiments, the method further comprises washing the stabilized ACC. According to some embodiments, the method further comprises drying the stabilized ACC.

According to some embodiments, the method of the present invention comprises the steps of:
(i) dissolving a base and sodium tripolyphosphate as a stabilizer in an aqueous solution, wherein the pH of the resulting aqueous solution is 8 or more;
(ii) bubbling or pressurizing CO₂ gas into the solution obtained in step (i) followed by adding MgSO₄ and optionally adding sodium tripolyphosphate as a stabilizer to the solution;
(iii) optionally adding sodium tripolyphosphate as a stabilizer to the solution obtained in step (ii), and
(iv) collecting the resulting amorphous magnesium carbonate,
   wherein the base is selected from NaOH and NH₄OH and is added in the amount equal to at least 2 equivalents of MgSO₄ and optionally wherein MgSO₄ is a heptohydrate. According to some embodiments, the method comprises adding a stabilizer at step (ii). According to some embodiments, the method comprises adding a stabilizer at step (iii). According to some embodiments, the method comprises adding a stabilizer at steps (ii) and (iii). According to some embodiments, the pH is maintained at the value equal to or above 8, equal to or above 9, equal to or above 10, equal to or above 11, or equal to or above 12 during the whole process of preparation. According to some embodiments, the pH is maintained at the value of from 8 to 12 during the whole process of preparation. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the stabilized AMC. According to some embodiments, the filtering is performed within 2 minutes from the addition of MgSO₄. According to some embodiments, the method further comprises washing the stabilized AMC. According to some embodiments, the method further comprises drying the stabilized AMC.

According to some embodiments, the method of the present invention comprises the steps of:
(i) dissolving a base and sodium tripolyphosphate as a stabilizer in an aqueous solution, wherein the pH of the resulting aqueous solution is 8 or more;
(ii) adding MgSO₄ and optionally sodium tripolyphosphate as a stabilizer to the solution obtained in step (i) followed by bubbling or pressurizing CO₂ gas and optionally adding sodium tripolyphosphate as a stabilizer to the solution;
(iii) optionally adding sodium tripolyphosphate as a stabilizer to the solution obtained in step (ii), and
(iv) collecting the resulting amorphous magnesium carbonate,
   wherein the base is selected from NaOH and NH₄OH and is added in the amount equal to at least 2 equivalents of MgSO₄ and optionally wherein MgSO₄ is a heptahydrate. According to some embodiments, the method comprises adding a stabilizer at step (ii). According to some embodiments, the method comprises adding a stabilizer at step (iii). According to some embodiments, the method comprises adding a stabilizer at steps (ii) and (iii). According to some embodiments, the pH is maintained at the value equal to or above 8, equal to or above 9, equal to or above 10, equal to or above 11, or equal to or above 12 during the whole process of preparation. According to some embodiments, the pH is maintained at the value of from 8 to 12 during the whole process of preparation. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the stabilized AMC. According to some embodiments, the filtering is performed within 2 minutes from the initiation of CO₂ bubbling. According to some embodiments, the method further comprises d the stabilized AMC. According to some embodiments, the method further comprises drying the stabilized AMC.

According to some embodiments, the method is for preparing a stabilized calcium carbonate and comprises: providing an aqueous solution having a pH equal to or above 8 and: (i) continuously adding to the aqueous solution a base, sodium triphosphate, and calcium chloride, (ii) continuously bubbling or pressurizing CO₂ gas into the solution, and (iii) continuously collecting the resulting amorphous calcium carbonate, wherein the base is selected from NaOH and NH₄OH and is added in the amount of at least 2 molar equivalents of calcium chloride and the pH is constantly maintained equal to or above 8 during the whole process. According to some embodiments, the pH of the initial solution is equal to or above 9, equal to or above 10, equal to or above 11, or equal to or above 12. According to some embodiments, the pH is maintained at the value equal to or above 8, equal to or above 9, equal to or above 10, equal to or above 11, or equal to or above 12 during the whole process. According to some embodiments, the pH is maintained at the value of from 8 to 12 during the whole process of preparation. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the stabilized ACC. According to some embodiments, the method further comprises drying the stabilized ACC. According to some embodiments, the method further comprises washing the stabilized ACC.

According to some embodiments, the method is for preparing a stabilized calcium carbonate and comprises: providing an aqueous solution having a pH equal to or above 8 and: (i) continuously adding to the aqueous solution a base, sodium triphosphate, and magnesium sulfate, (ii) continuously bubbling or pressurizing CO₂ gas into the solution, and (iii) collecting the resulting amorphous calcium carbonate, wherein the base is selected from NaOH and NH₄OH and is added in the amount of at least 2 molar equivalents of calcium chloride and the pH is constantly maintained equal to or above 8 during the whole process. According to some embodiments, the pH of the initial solution is equal to or above 9, equal to or above 10, equal to or above 11, or equal to or above 12. According to some embodiments, the pH is maintained at the value equal to or above 8, equal to or above 9, equal to or above 10, equal to or above 11, or equal to or above 12 during the whole process. According to some embodiments, the pH is maintained at the value of from 8 to 12 during the whole process of preparation. According to some embodiments, the reaction is performed at ambient pressure. According to other embodiments, the reaction is performed at a pressure of from 1 to 60 or from 5 to 56 bars. According to some embodiments, the pH is kept above 10 during the process. According to some embodiments, the method further comprises filtering the stabilized AMC. According to some embodiments, the method further comprises drying the stabilized AMC. According to some embodiments, the method further comprises washing the stabilized AMC.

According to another aspect, the present invention provides a stabilized amorphous calcium carbonate prepared by a method according to any one of the above embodiments and aspects. All terms, embodiments and definitions disclosed in any one of the above aspects apply and are encompassed herein as well.

According to some embodiments, the present invention provides a stabilized carbonate of alkaline earth metal obtained or obtainable by the method comprising:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; or
   adding a salt of an alkaline earth metal into the solution obtained in step (i) followed by bubbling or pressurizing CO₂ gas into the solution,
   thereby precipitating an amorphous alkaline earth metal carbonate, and
(iii) collecting the resulting amorphous alkaline earth metal carbonate precipitate,
   wherein the method comprises adding at least one stabilizer in at least one of the following stages: (a) before bubbling or pressurizing CO₂ gas; (b) after bubbling or pressurizing CO₂ gas; (c) before adding a salt of an alkaline earth metal, (d) together with adding a salt of an alkaline earth metal or (e) after adding a salt of an alkaline earth metal.

According to some embodiments, the present invention provides a stabilized carbonate of alkaline earth metal obtained or obtainable by the method comprising:
(i) dissolving a base and a stabilizer in an aqueous solution, wherein the resulting solution has a pH equal to or above 8;
(ii) bubbling or pressurizing CO₂ gas into the solution obtained in step (i) followed by adding a salt of an alkaline earth metal and optionally adding a stabilizer to the solution; or adding a salt of an alkaline earth metal into the solution obtained in step (i) followed by bubbling or pressurizing CO₂ gas into the solution and optionally adding a stabilizer,
(iii) thereby precipitating the stabilized alkaline earth metal carbonate;
(iv) optionally adding a stabilizer to the solution obtained in step (ii), and
(v) collecting the resulting amorphous alkaline earth metal carbonate,
   wherein CO₂ is introduced into the solutions constantly during step (ii) and (iii), if present, and the stabilizer in steps (i) and in steps (ii) and/or (iii), if present, is the same or different.

According to some embodiments, the present invention provides a stabilized carbonate of alkaline earth metal obtained or obtainable by the method comprising:
(i) dissolving a base in an aqueous solution;
(ii) dissolving a stabilizer in the solution obtained in step (i) and followed by bubbling or pressurizing CO₂ gas into the solution, wherein dissolving the stabilizer and starting the CO₂ introduction by bubbling or pressurizing is performed in either order;
(iii) adding a salt of an alkaline earth metal and optionally a stabilizer to the solutions obtained in step (ii), thereby precipitating the amorphous alkaline earth metal carbonate; and
(iv) optionally adding a stabilizer to the solution obtained in step (iii),
   wherein CO₂ is introduced into the solutions constantly during steps (ii) and (iii), and the stabilizer in steps (ii), and in steps (iii) and (iv), if added, is the same or different.

According to some embodiments, the present invention provides a stabilized amorphous calcium carbonate obtained or obtainable by the method comprising:
(i) dissolving a NaOH or NH₄OH in an aqueous solution to obtain pH 10 or more;
(ii) dissolving sodium tripolyphosphate in the solution obtained in step (i) and start bubbling or pressurizing CO₂ gas into the solution;
(iii) adding a halide or sulfate of alkaline earth metal to the solutions of step (ii);
(iv) adding sodium tripolyphosphate to the solution of step (iii) or together with step (iii),
   wherein CO₂ is introduced into the solutions constantly during steps (ii) and (iii), and
   wherein NaOH or NH₄OH is added in the amount equal to 2 or more molar equivalents of added alkaline earth metal.

According to some embodiments, the present invention provides a stabilized amorphous calcium carbonate obtained or obtainable by the method comprising:
(i) dissolving a base in an aqueous solution;
(ii) dissolving a stabilizer in the solution obtained in step (i) and followed by bubbling or pressurizing CO₂ gas into the solution, wherein dissolving the stabilizer and starting the CO₂ introduction by bubbling or pressurizing is performed in either order;
(iii) adding calcium salt, e.g., calcium chloride and optionally a stabilizer to the solutions obtained in step (ii), thereby precipitating the ACC; and
(iv) optionally adding a stabilizer to the solution obtained in step (iii),
   wherein CO₂ is introduced into the solutions constantly during steps (ii) and (iii), and the stabilizer in steps (ii), and in steps (iii) and (iv), if added, is the same or different.

According to some embodiments, the present invention provides a stabilized amorphous calcium carbonate obtained or obtainable by the method comprising:
(i) dissolving a NaOH or NH₄OH in an aqueous solution to obtain pH 10 or more;
(ii) dissolving sodium tripolyphosphate in the solution obtained of step (i) and start bubbling or pressurizing CO₂ gas into the solution;
(iii) adding CaCl₂) to the solutions of step (ii);
(iv) adding sodium tripolyphosphate to the solution of step (iii) or together with step (iii),
   wherein CO₂ is introduced into the solutions constantly during steps (ii) and (iii), and
   wherein NaOH or NH₄OH is added in the amount equal to 2 or more molar equivalents of added CaCl₂).

According to some embodiments, the present invention provides a stabilized amorphous magnesium carbonate obtained or obtainable by the method comprising:
(i) dissolving a base in an aqueous solution;
(ii) dissolving a stabilizer in the solution obtained in step (i) and followed bubbling or pressurizing CO₂ gas into the solution, wherein dissolving the stabilizer and starting the CO₂ introduction by bubbling or pressurizing is performed in either order;
(iii) adding a magnesium salt e.g., magnesium sulfate and optionally a stabilizer to the solutions obtained in step (ii), thereby precipitating the ACC; and
(iv) optionally adding a stabilizer to the solution obtained in step (iii),
   wherein CO₂ is introduced into the solutions constantly during steps (ii) and (iii), and the stabilizer in steps (ii), and in steps (iii) and (iv), if added, is the same or different.

According to some embodiments, the present invention provides a stabilized amorphous magnesium carbonate obtained or obtainable by the method comprising:
(i) dissolving a NaOH or NH₄OH in an aqueous solution to obtain pH 10 or more;
(ii) dissolving sodium tripolyphosphate in the solution obtained of step (i) and start bubbling or pressurizing CO₂ gas into the solution;
(iii) adding MgCl₂ or magnesium sulfate to the solutions of step (ii);
(iv) adding sodium tripolyphosphate to the solution of step (iii) or together with step (iii),
   wherein CO₂ is introduced into the solutions constantly during steps (ii) and (iii), and
   wherein NaOH or NH₄OH is added in the amount equal to 2 or more molar equivalents of added magnesium salt.

According to some embodiments, the present invention provides a stabilized amorphous magnesium carbonate obtained or obtainable by the method comprising:
(i) dissolving NaOH or NH₄OH and sodium tripolyphosphate as a stabilizer in an aqueous solution, wherein the pH of the resulting aqueous solution is 8 or more;
(ii) bubbling or pressurizing CO₂ gas into the solution obtained in step (i) followed by adding CaCl₂) and/or NH₄OH and optionally adding sodium tripolyphosphate as a stabilizer to the solution;
(iii) optionally adding sodium tripolyphosphate as a stabilizer to the solution obtained in step (ii), and
(iv) collecting the resulting amorphous carbonate of Ca and/or Mg.

According to some embodiments, the present invention provides a stabilized amorphous magnesium carbonate obtained or obtainable by the method comprising:
(i) dissolving NaOH or NH₄OH and sodium tripolyphosphate as a stabilizer in an aqueous solution, wherein the pH of the resulting aqueous solution is 8 or more;
(ii) adding CaCl₂) or MgSO₄ and optionally sodium tripolyphosphate as a stabilizer to the solution obtained in step (i) followed by bubbling or pressurizing CO₂ gas;
(iii) optionally adding sodium tripolyphosphate as a stabilizer to the solution obtained in step (ii), and
(iv) collecting the resulting amorphous carbonate of Ca and/or Mg.

According to some embodiments, the present invention provides a stabilized carbonate of alkaline earth metal obtained or obtainable by the method comprising providing an aqueous solution having a pH equal to or above 8 and: (i) continuously adding to the aqueous solution a base, at least one stabilizer, and an alkaline earth metal or a salt thereof, (ii) continuously bubbling or pressurizing CO₂ gas into the solution, and (iii) continuously collecting the resulting stabilized amorphous alkaline earth metal carbonate, wherein the pH is maintained equal to or above 8 during the whole process. According to some embodiments, the alkaline earth metal or a salt thereof is selected from CaCl₂) and MgSO₄.

According to yet another aspect, the present invention provides a use of the stabilized amorphous alkaline earth metal carbonate, e.g., ACC, AMC and combinations thereof in agriculture and in veterinary.

Having now generally described the invention, the same will be more readily understood through reference to the following examples, which are provided by way of illustration and are not intended to be limiting of the present invention.

### EXAMPLES

The characteristics of the products prepared in the examples described herein are provided in Table 1 below. Several Examples were repeated with slightly varied conditions. Detailed description of these variations is presented in Table 1.

### Example 1. Preparation of ACC with CO₂ Bubbling at Atmospheric Pressure, with 10% Stabilizer, Introduced in One Addition Step and Two Equivalents of NaOH

Sodium hydroxide pellets (7 g, two molar equivalents of CaCl₂)) were dissolved in 250 ml of deionized water. A stabilizer (Sodium TriPolyPhosphate, STPP, also known as sodium triphosphate) was then dissolved in the solution (1.26 g, 10 wt % of the amount of CaCl₂·2H₂O). The CO₂ gas was bubbled through the solution for at least 2 minutes before adding the calcium reagent, and continuously bubbled throughout the reaction after adding the calcium source. An amount of 12.61 g of CaCl₂·2H₂O was added in small portions (due to the exothermic reaction), till it was dissolved in the above solution mixture with a constant gentle CO₂ flow. The reaction mixture was homogenized by a homogenizer and CO₂ was further bubbled into the reaction mixture for an overall time of 10 minutes to yield 3.2 g of a white solid after filtration, washing with water and drying. In this particular example, the solid was dried in an oven at 100° C. with air purging for 15 minutes. The calculated yield was about 30% based on assumed ACC composition and the molar amount of the calcium source).

### Example 2. Preparation of ACC with CO₂ Bubbling at Atmospheric Pressure, With 5% Stabilizer, Introduced in One Step and Two Equivalents of NaOH

Sodium hydroxide pellets (7 g, two molar equivalents of CaCl₂)) were dissolved in 200 ml of deionized water. A stabilizer (Sodium TriPolyPhosphate, STPP) was then dissolved in the solution (0.63 g, 5 wt % of the amount of CaCl₂·2H₂O). The CO₂ gas was bubbled through the solution before adding the calcium source to degas the solution from other gases, and continuously bubbled throughout the reaction after adding the calcium source. An amount of 12.61 g of CaCl₂·2H₂O, dissolved in 50 ml deionized water was added into the above solution mixture with a constant gentle CO₂ flow. The reaction mixture was homogenized by a homogenizer and CO₂ was further bubbled into the reaction mixture for an overall time of 10 minutes to yield 7.8 g of a white solid (73% yield based on assumed ACC composition and the molar amount of the calcium source). The content of calcium was 39.7 wt %. The surface area of the resulting ACC is 18.49 m²/g.

### Example 3. Preparation of ACC with CO₂ Bubbling at Atmospheric Pressure and 10% Stabilizer, Added in Two Portions and Two Equivalents of NaOH

An amount of NaOH pellets (7 g, two equivalents) was dissolved in 250 ml of deionized water. A stabilizer (sodium tripolyphosphate, STPP) was then dissolved (0.63 g, 5 wt % of the amount of CaCl₂·2H₂O). Then, CO₂ gas was bubbled through this solution for various periods before adding the calcium source, and continuously bubbled throughout the reaction with the calcium source. An amount of 12.61 g of CaCl₂·2H₂O was added in small portions (the reaction is exothermic), till it was dissolved in the above solution mixture with a constant gentle CO₂ flow. The reaction mixture was homogenized by a homogenizer and CO₂ was further bubbled into the reaction mixture. Another portion of 0.63 g STPP was added, and the reaction was continued for additional 5 min. The overall yield was 5.5 g of a white solid (51% yield) with the content of calcium of 34.4 wt %. The surface area of the resulting ACC is 11 m²/g.

The reaction may be performed with higher pressure, (from 5 bars to 200 bars). It can be executed with additional ionic sources of other metals (e.g., Mg, Fe, Mn, Cr, Co, etc.)

It seems that by increasing the amount of base it is possible to increase the yield of the reaction.

### Example 4. Preparation of ACC with CO₂ Bubbling at Atmospheric Pressure without Sodium Hydroxide and 10% Stabilizer Added in One Addition

To a conical flask filled with 250 ml of deionized water, under atmospheric pressure, 1.26 g (10 wt % of the amount of CaCl₂·2H₂O) of a stabilizer (sodium tripolyphosphate, STPP) was dissolved. An amount of 12.61 g of CaCl₂·2H₂O was added in small portions (the reaction is exothermic), till it was dissolved in the above solution mixture with a constant gentle CO₂ flow. The reaction mixture was homogenized with a homogenizer and CO₂ was further bubbled into the reaction mixture for a total time of 10 min. The yield of the recovered product was only 1.2 g, and TGA indicated the release of only 2 wt % CO₂, indicating very low content of a carbonate product. This product was found to be amorphous.

### Example 5. Preparation of ACC with CO₂ Bubbling at Atmospheric Pressure without Sodium Hydroxide and 10% Stabilizer Added in Two Steps

In a conical flask filled with 250 ml of deionized water, under atmospheric pressure, 0.63 g (5 wt % of the amount of CaCl₂·2H₂O) of a stabilizer (sodium tripolyphosphate, STPP) was dissolved. An amount of 12.61 g of CaCl₂·2H₂O was added in small portions till it was dissolved in the above solution mixture with a constant gentle CO₂ flow. Another 0.63 g portion of the stabilizer was added as a powder. The reaction mixture was homogenized by a homogenizer and CO₂ was further bubbled into the reaction mixture for a total time of 10 min. The yield of the recovered product was only 1 g, and TGA indicated the release of only 2 wt % CO₂, indicating very low content of calcium carbonate. This material was amorphous.

### Example 6. Preparation of ACC with CO₂ Bubbling at Atmospheric Pressure without Sodium Hydroxide, 10% Stabilizer Added in Two Steps

In a conical flask filled with 250 ml of deionized water, under atmospheric pressure, 0.63 g (5 wt % of the amount of CaCl₂·2H₂O) of a stabilizer (sodium tripolyphosphate, STPP) was dissolved. An amount of 12.61 g of CaCl₂·2H₂O was added in small portions till it was dissolved in the above solution mixture with a constant gentle CO₂ flow. Another portion of 0.63 g STPP was added, and the reaction mixture was homogenized by a homogenizer and CO₂ was further bubbled into the reaction mixture for a total time of 10 min. The yield of the recovered product was only 1.2 g, and TGA indicated the release of only 2 wt % CO₂, indicating very low content of calcium carbonate. This material was amorphous and comprises 23.9% calcium. The surface area of the resulting ACC is 32.9 m²/g.

### Example 7. Preparation of ACC with CO₂ Bubbling at Atmospheric Pressure, 10% Stabilizer Added in a Single Addition and Three Equivalents of Sodium Hydroxide

Sodium hydroxide pellets (10.5 g; 3 equivalents compared to CaCl₂·2H₂O) were dissolved in 200 ml of deionized water, a stabilizer (sodium tripolyphosphate, STPP) was then dissolved in the solution (1.26 g 10 wt % of the amount of CaCl₂·2H₂O). Then CO₂ was bubbled through this solution before adding the calcium source, and continuously bubbled throughout the reaction with the calcium source. An amount of 12.61 g of CaCl₂·2H₂O, dissolved in 50 ml water was added with a constant gentle CO₂ flow. The reaction mixture was homogenized by a homogenizer and CO₂ was further bubbled into the reaction mixture for an overall time of 10 minutes to yield 9.5 g of white solid (88% yield for ACC). The content of calcium was 34.3 wt %. The surface area of the resulting ACC is 44.45 m²/g.

### Example 8. Preparation of ACC with CO₂ Bubbling at Atmospheric Pressure, Calcium Chloride, Sodium Tripolyphosphate (STPP) as a Stabilizer (Single Addition) and Three Equivalents of Sodium Hydroxide

Sodium hydroxide pellets (10.5 g; 3 equivalents compared to CaCl₂·2H₂O) were dissolved in 150 ml of deionized water, a stabilizer (sodium tripolyphosphate, STPP) was then dissolved in the solution (1.26 g 10 wt % of the amount of CaCl₂·2H₂O). Then, CO₂ gas was bubbled through this solution before adding the calcium source, and continuously bubbled throughout the reaction with the calcium source. An amount of 12.61 g of CaCl₂·2H₂O, dissolved in 50 ml water was added with a constant gentle CO₂ flow. The reaction mixture was homogenized by a homogenizer and CO₂ was further bubbled into the reaction mixture for an overall time of 10 minutes to yield 7.6 g of white solid (71% yield for ACC). The surface area of the resulting ACC is 28.6 m²/g.

### Example 9. Preparation of ACC with CO₂ Bubbling at Atmospheric Pressure, 10% Stabilizer Added in Two Portions and Three Equivalents of Sodium Hydroxide

Sodium hydroxide pellets (10.5 g; 3 equivalents compared to CaCl₂·2H₂O) were dissolved in 200 ml of deionized water, a stabilizer (sodium tripolyphosphate, STPP) was then dissolved in the solution (0.63 g 5 wt % of the amount of CaCl₂·2H₂O). Then CO₂ was bubbled through this solution before adding the calcium source, and continuously bubbled throughout the reaction with the calcium source. An amount of 12.61 g of CaCl₂·2H₂O and another portion of 0.63 g STPP dissolved in 50 ml water were added with a constant gentle CO₂ flow. The reaction mixture was homogenized by a homogenizer and CO₂ was further bubbled into the reaction mixture and the reaction was continued for additional 5 minutes. The overall yield was 9.5 g of white solid (88% yield for ACC).

### Example 10. Preparation of ACC in the Presence of 10 Bars of CO₂ in a 1 L Pressure Reactor, 10% Stabilizer Added in a Single Step and Three Equivalents of Sodium Hydroxide

Sodium hydroxide pellets (10.5 g; 3 equivalents compared to CaCl₂·2H₂O) were dissolved in 200 ml of deionized water, a stabilizer (sodium tripolyphosphate, STPP) was then dissolved in the solution (1.26 g, 10 wt % of the amount of CaCl₂·2H₂O). An amount of 12.61 g of CaCl₂·2H₂O, dissolved in 50 ml water was added at once to the above mixture, the resulting solution was blended and then introduced into a pressure reactor. Then CO₂ gas was flushed through the solution in the reactor to degas the solution. The reactor was sealed and pressurized at 10 bars of CO₂ for 10 minutes. The reaction mixture was stirred by a mechanical rotor stirring shaft set at 1000 rpm. The reaction yield was 6.9 g of white solid (64% yield for ACC) after filtration, washing with water and drying in oven at 100° C. with air purging for 15 minutes.

### Example 11. Preparation of ACC in the Presence of 10 Bars of CO₂ in a 1 L Pressure Reactor, 10% Stabilizer Added in Two Steps and Three Equivalents of Sodium Hydroxide

Sodium hydroxide pellets (10.5 g; 3 equivalents compared to CaCl₂·2H₂O) were dissolved in 200 ml of deionized water, a stabilizer (sodium tripolyphosphate, STPP) was then dissolved in the solution (0.63 g 5 wt % of the amount of CaCl₂·2H₂O). An amount of 12.61 g of CaCl₂·2H₂O, dissolved in 40 ml water, a stabilizer (sodium tripolyphosphate, STPP) was then dissolved separately in 10 ml water (0.63 g, 5 wt % of the amount of CaCl₂·2H₂O), the Calcium solution and the STPP solution were premixed to a total volume of 50 ml and added at once to the above 200 ml mixture. The resulting solution was blended, added into the reactor, and CO₂ was flushed through the solution in the reactor. Then the reactor was sealed, and the pressure was set at 10 bars for 10 minutes. The reaction mixture was stirred with a mechanical rotor stirring shaft set at 1000 rpm. The product yield was 7.1 g of white solid (66% yield for ACC) after filtration, washing and drying in oven at 100° C. with air purging for 15 minutes.

### Example 12. Preparation of ACC in the Presence of 10 Bars of CO₂ in a 1 L Pressure Reactor, 10% Stabilizer Added in a Single Step and Two Equivalents of Sodium Hydroxide

Sodium hydroxide pellets (7 g; 2 equivalents compared to CaCl₂·2H₂O) were dissolved in 200 ml of deionized water, a stabilizer (sodium tripolyphosphate, STPP) was then dissolved in the solution (1.26 g 10 wt % of the amount of CaCl₂·2H₂O). An amount of 12.61 g of CaCl₂·2H₂O, dissolved in 50 ml water was added at once to the above mixture, the resulting solution was blended and added to the reactor. CO₂ was flushed through the solution in the reactor. Then the reactor was sealed, and the CO₂ pressure was set at 10 bars for an overall time of 10 minutes. The reaction mixture was blend with a mechanical rotor stirring shaft set at 1000 rpm to yield 6.7 g of white solid (62% yield for ACC).

### Example 13. Preparation of ACC in the Presence of 10 Bars of CO₂ in a 1 L Pressure Reactor, 10% Stabilizer Added in Two Steps and Two Equivalents of Sodium Hydroxide

Sodium hydroxide pellets (7 g; 2 equivalents compared to CaCl₂·2H₂O) were dissolved in 200 ml of deionized water, a stabilizer (sodium tripolyphosphate, STPP) was then dissolved in the solution (0.63 g 5 wt. % of the amount of CaCl₂·2H₂O). An amount of 12.61 g of CaCl₂·2H₂O, dissolved in 40 ml water, a stabilizer (sodium tripolyphosphate, STPP) was then dissolved separately in 10 ml water (0.63 g 5 wt. % of the amount of CaCl₂·2H₂O), the Calcium solution and the STPP solution were premixed to a total volume of 50 ml and added at once to the above 200 ml mixture. The resulting solution was blended and added to the reactor and CO₂ was flushed through the solution in the reactor. Then the reactor was sealed, and the CO₂ pressure was set at 10 bars for an overall time of 10 minutes. The reaction mixture was stirred by a mechanical rotor stirring shaft set at 1000 rpm to yield 6.7 g of white solid (62% yield for ACC).

### Example 14. Preparation of ACC in the Presence of 20 Bars of CO₂ in a 1 L Pressure Reactor, 10% Stabilizer Added in Two Steps and Two Equivalents of Sodium Hydroxide

Sodium hydroxide pellets (7 g; 2 equivalents compared to CaCl₂·2H₂O) were dissolved in 250 ml of deionized water, a stabilizer (sodium tripolyphosphate, STPP) was then dissolved in the solution (0.63 g 5 wt. % of the amount of CaCl₂·2H₂O) and CO₂ was pressurized into the sealed reactor for 10 min at room temperature at 20 bars. The reactor was opened, the solution was transferred to a conical flask and the mixture was blended with a homogenizer. An amount of 12.61 g of powdered CaCl₂·2H₂O was added to the above mix followed with the addition of a powdered stabilizer 0.63 g (sodium tripolyphosphate, STPP 5 wt % of the amount of CaCl₂·2H₂O). The resulting solution was homogenized for additional 3 min. to yield 7.7 g of white solid (72% yield for ACC).

### Example 15. Preparation of ACC in the Presence of 20 Bars of CO₂ in a 1 L Pressure Reactor. 10% of Stabilizer Added in Two Steps and Three Equivalents of Sodium Hydroxide

Sodium hydroxide pellets (10.5 g; 3 equivalents compared to CaCl₂·2H₂O) were dissolved in 250 ml of deionized water, a stabilizer (sodium tripolyphosphate, STPP) was then dissolved in the solution (0.63 g 5 wt. % of the amount of CaCl₂·2H₂O) and CO₂ was pressurized into the sealed reactor for 10 min at room temperature at 20 bars. The reactor was opened, the solution was transferred to a conical flask and the mixture was blended with a homogenizer. An amount of 12.61 g of powdered CaCl₂·2H₂O was added to the above mix followed by the addition of a powdered stabilizer 0.63 g (sodium tripolyphosphate, STPP 5 wt. % of the amount of CaCl₂·2H₂O). The resulting solution was homogenized for an additional 3 min. to yield 10.4 g of white solid (97% yield for ACC).

### Example 16. Preparation of ACC in the Presence of 20 Bars of CO₂ in a 1 L Pressure Reactor, 10% Stabilizer Added in Two Addition and Two Equivalents of Sodium Hydroxide

Sodium hydroxide pellets (7 g; 2 equivalents compared to CaCl₂·2H₂O) were dissolved in 200 ml of deionized water, a stabilizer (sodium tripolyphosphate, STPP) was then dissolved in the solution (0.63 g 5 wt. % of the amount of CaCl₂·2H₂O) and CO₂ was pressurized into the sealed reactor for 10 min at room temperature at 20 bars. The reactor was opened, the solution was transferred to a conical flask and the mixture was blended by a homogenizer. An amount of 12.61 g of powdered CaCl₂·2H₂O dissolved in 40 ml deionized water was added to the above mix followed with the addition of a powdered stabilizer 0.63 g dissolved in 10 ml deionized water (sodium tripolyphosphate, STPP 5 wt % of the amount of CaCl₂·2H₂O). The resulting solution was homogenized for additional 3 min. to yield 7.6 g of white solid (71% yield for ACC).

### Example 17. Preparation of ACC in the Presence of 20 Bars of CO₂ in a 1 L Pressure Reactor, 10% of Stabilizer Added in Two Steps and Three Equivalents of Sodium Hydroxide

Sodium hydroxide pellets (10.5 g; 3 equivalents compared to CaCl₂·2H₂O) were dissolved in 200 ml of deionized water, a stabilizer (sodium tripolyphosphate, STPP) was then dissolved in the solution (0.63 g, 5 wt. % of the amount of CaCl₂·2H₂O) and CO₂ was pressurized into the sealed reactor for 10 min at room temperature at 20 bars. The reactor was opened, the solution was transferred to a conical flask and the mixture was blended by a homogenizer. An amount of 12.61 g of powdered CaCl₂·2H₂O dissolved in 40 ml deionized water was added to the above mix followed with the addition of a powdered stabilizer 0.63 g dissolved in 10 ml deionized water (sodium tripolyphosphate, STPP 5 wt. % of the amount of CaCl₂·2H₂O). The resulting solution was homogenized for additional 3 min to yield 9.8 g of white solid (91% yield for ACC).

### Example 18. Preparation of ACC in the Presence of 10 Bars of CO₂ in a 1 L Pressure Reactor, 10% Stabilizer Added in a Single Step, without Sodium Hydroxide

To 200 ml of deionized water, a stabilizer (sodium tripolyphosphate, STPP) was dissolved in the solution (1.26 g 10 wt % of the amount of CaCl₂·2H₂O). An amount of 12.61 g of CaCl₂·2H₂O, dissolved in 50 ml water was added at once to the above mixture, the resulting solution was blended and added to the reactor. CO₂ was flushed through the solution in the reactor. Then the reactor was sealed, and the pressure was set to 10 bars for an overall time of 10 minutes. The reaction mixture was stirred with a mechanical rotor stirring shaft set at 1000 rpm to yield 1.1 g of white solid (10% yield for ACC).

### Example 19. Preparation of ACC in the Presence of 20 Bars of CO₂ in a 1 L Pressure Reactor, 10% Stabilizer Added in a Single Step, without Sodium Hydroxide

To 200 ml of deionized water, a stabilizer (sodium tripolyphosphate, STPP) was dissolved in the solution (1.26 g 10 wt % of the amount of CaCl₂·2H₂O). An amount of 12.61 g of CaCl₂·2H₂O, dissolved in 50 ml water was added at once to the above mixture, the resulting solution was blended and added into the reactor. CO₂ gas was flushed through the solution in the reactor. Then the reactor was sealed, and the pressure was set to 20 bars for an overall time of 10 minutes. The reaction mixture was stirred with a mechanical rotor stirring shaft set at 1000 rpm to yield 1.1 g of white solid (10% yield for ACC).

### Example 20. Same Preparation as in Example 7 and Example 12 but without the Addition of a Stabilizer

When ACC was prepared as detailed in Examples 7 and 12 without adding a stabilizer, the resulting ACC crystallized instantly in the solution.

### Example 21. Preparation of ACC in the Presence of 10 Bars of CO₂ in a 1 L Pressure Reactor, 10% Stabilizer Added in a Single Step, with 2 Equivalents of NH₄OH Solution (2730)

Ammonium Hydroxide Solution (25 wt % NH₃) (11.7 ml; 2 equivalents compared to CaCl₂·2H₂O) were dissolved in 200 ml of deionized water, a stabilizer (sodium tripolyphosphate, STPP) was then dissolved in the solution (1.26 g, 10 wt. % of the amount of CaCl₂·2H₂O). The CO₂ was bubbled through the solution before adding the calcium source. An amount of 12.61 g of CaCl₂·2H₂O dissolved in 50 ml deionized water was added in the above solution mixture with a constant gentle CO₂ gas flow. The reactor was sealed, and the reaction continued for one minute at 10 bars at 25° C. while stirring with a mechanical rotor shaft set at 1000 RPM. The reaction was terminated after 1 minute, then the reactor was opened, the product was filtered on a Buchner with a filter paper. The Product was dried in the oven at 100° C. with a vent to yield 8.8 g of white solid (82% yield for ACC). The ACC Amorphous content was 100% as measured with XRD. The Loss on Drying of ACC was 10.4% and the content of calcium was 32.9 wt %.

### Example 22. Preparation of AMC in the Presence of 15 Bars of CO₂ in a 1 L Pressure Reactor, 6.4% of Stabilizer Added in One Addition and Two Equivalents of Ammonium Hydroxide. (2754)

To 200 ml of deionized water, a stabilizer (sodium tripolyphosphate, STPP) was dissolved in the solution (0.898 g 6.4 wt. % of the amount of MgSO₄) together with ammonia liquid solution 25% wt. (2 equivalents compared to MgSO₄, 15.8 ml). An amount of 28.57 g of MgSO₄₇H₂O, dissolved in 50 ml water was added at once to the above mixture, the resulting solution was blended for 30 seconds and added into the reactor. CO₂ gas was flushed through the solution in the reactor. Then the reactor was sealed, and the pressure was set to 15 bars for an overall time of 3 minutes. The reaction mixture was stirred with a mechanical rotor shaft set at 1000 rpm to yield 1 g of white solid after precipitation with 30 ml ethanol. The product was washed with 500 ml deionized water to remove unreacted starting materials and salts and dried in the oven without vent to a constant L.O.D. of 4.7%, XRD 100% AMC (6% yield for AMC).

### Example 23. Preparation of AMC in the Presence of 15 Bars of CO₂ in a 1 L Pressure Reactor 6.4% of Stabilizer Added in One Addition and Two Equivalents of Ammonium Hydroxide (2755)

In 200 ml of deionized water, a stabilizer (sodium tripolyphosphate, STPP) was dissolved in the solution (0.898 g 6.4 wt % of the amount of MgSO₄) together with ammonia liquid solution 25% wt. (2 equivalents compared to MgSO₄, 15.8 ml). An amount of 28.57 g of MgSO₄₇H₂O, dissolved in 50 ml water was added at once to the above mixture, the resulting solution was blended for 30 seconds and added into the reactor. CO₂ gas was flushed through the solution in the reactor. Then the reactor was sealed, and the pressure was set to 15 bars for an overall time of 5 minutes. The reaction mixture was stirred by a mechanical rotor shaft set at 1000 rpm to yield 1.5 g of white solid after precipitation with 50 ml ethanol. The product was washed with 500 ml deionized water to remove unreacted starting materials and salts and dried in the oven without vent to a constant L.O.D. of 5.1%, XRD 100% AMC (9.4% yield for AMC).

### Example 24. Preparation of AMC in the Presence of 15 Bars of CO₂ in a 1 L Pressure Reactor, No Stabilizer Added and Two Equivalents of Ammonia Liquid (2761)

To 200 ml of deionized water, ammonia liquid solution 25% wt. (2 equivalents, 15.8 ml). An amount of 28.57 g of MgSO₄₇H₂O, dissolved in 50 ml water was added at once to the above solution, the resulting mixture was blended for 30 seconds and added into the reactor. CO₂ was flushed through the solution in the reactor. Then the reactor was sealed, and the pressure was set to 15 bars for an overall time of 3 minutes. The reaction mixture was stirred by a mechanical rotor stirring shaft set at 1000 rpm to yield 1.1 g of white solid after precipitation with 50 ml ethanol. The product was washed with 500 ml deionized water to remove unreacted starting materials and salts and dried in the oven without vent to a constant L.O.D. of 3.6%, XRD Mostly AMC and Minor Nesquehonite (6% yield for AMC).

### Example 25. Preparation of AMC in the Presence of 15 Bars of CO₂ in a 1 L Pressurize Reactor 6.4% of Stabilizer Added in One Addition and Two Equivalents of Ammonium(2766)

To 200 ml of deionized water, ammonia liquid solution 25% wt. (2 equivalents, 15.8 ml) was added together with a stabilizer (sodium tripolyphosphate, STPP, 0.898 g, 6.4 wt % of the amount of MgSO₄). An amount of 28.57 g of MgSO₄₇H₂O, dissolved in 50 ml water was added at once to the above solution, the resulting mixture was blended for 30 seconds and added into the reactor. CO₂ was flushed through the solution in the reactor. Then the reactor was sealed, and the pressure was set to 15 bars for an overall time of 3 minutes. The reaction mixture was stirred by a mechanical rotor stirring shaft set at 1000 rpm to yield 6.3 g of white solid after precipitation with 50 ml ethanol. The product was isolated as is, without washing with deionized water and dried in the oven without vent to a constant L.O.D. of 5.4%, XRD 100% AMC (55% yield for AMC).

### Example 26. Preparation of ACC in the Presence of 10 Bars of CO₂ in a 1 L Pressure Reactor, 10% Stabilizer Added in a Single Step, with 2 Equivalents of NH₄OH Solution

Ammonium Hydroxide Solution (25 wt % NH₃) (11.7 ml; 2 equivalents compared to CaCl₂·2H₂O) are dissolved in 200 ml of deionized water, a stabilizer (pyrophosphate, hexametaphosphate, phytic acid, or citric acid) is then dissolved in the solution (10 wt. % of the amount of CaCl₂·2H₂O). The CO₂ was bubbled through the solution before adding the calcium source. An amount of 12.61 g of CaCl₂·2H₂O dissolved in 50 ml deionized water is added into the above solution mixture with a constant gentle CO₂ gas flow. The reactor is sealed, and the reaction continues for one minute at 10 bars at 25° C. while stirring with a mechanical rotor shaft set at 1000 RPM. The reaction is terminated after 1 minute, then the reactor is opened, and the product is filtered on a Buchner with a filter paper. The Product is dried in the oven at 100° C. with a vent to yield 8-10 g of white solid. The ACC Amorphous content is 100% as measured with XRD.

### Example 27. Preparation of AMC in the Presence of 15 Bars of CO₂ in a 1 L Pressurize Reactor 6.4% of Stabilizer Added in One Addition and Two Equivalents of Ammonium

In 200 ml of deionized water, ammonia liquid solution 25% wt. (2 equivalents, 15.8 ml) is added with a stabilizer (pyrophosphate, hexametaphosphate, phytic acid, or citric acid, 6.4 wt % of the amount of MgSO₄). An amount of 28.57 g of MgSO₄·7H₂O, dissolved in 50 ml water is added at once to the above solution, the resulting mixture was blended for 30 seconds and added into the reactor. CO₂ is flushed through the solution in the reactor. Then the reactor is sealed, and the pressure is set to 15 bars for an overall time of 3 minutes. The reaction mixture is stirred by a mechanical rotor stirring shaft set at 1000 rpm to yield 6.3 g of white solid after precipitation with 50 ml ethanol. The product is isolated as is, without washing with deionized water and dried in the oven without vent to a constant L.O.D. of about 5.5%, XRD 100% AMC (˜55% yield for AMC).

### Example 28. Preparation of ACC in the Presence of 10 Bars of CO₂ in a 1 L Pressure Reactor, 10% Stabilizer Added in a Single Step, with 2 Equivalents of NH₄OH

### Solution

Ammonium Hydroxide Solution (25 wt % NH₃) (11.7 ml; 2 equivalents compared to CaCl₂·2H₂O) are dissolved in 200 ml of deionized water, a stabilizer (tripolyphosphate in combination with one of the followings: pyrophosphate, hexametaphosphate, phytic acid, or citric acid) is then dissolved in the solution (10 wt. % of the amount of CaCl₂·2H₂O). The CO₂ was bubbled through the solution before adding the calcium source. An amount of 12.61 g of CaCl₂·2H₂O dissolved in 50 ml deionized water is added into the above solution mixture with a constant gentle CO₂ gas flow. The reactor is sealed, and the reaction continues for one minute at 10 bars at 25° C. while stirring with a mechanical rotor shaft set at 1000 RPM. The reaction is terminated after 1 minute, then the reactor is opened, and the product is filtered on a Buchner with a filter paper. The Product is dried in the oven at 100° C. with a vent to yield 8-10 g of white solid. The ACC Amorphous content is 100% as measured with XRD.

### Example 29. Preparation of AMC in the Presence of 15 Bars of CO₂ in a 1 L Pressurize Reactor 6.4% of Stabilizer Added in One Addition and Two Equivalents of Ammonium

In 200 ml of deionized water, ammonia liquid solution 25% wt. (2 equivalents, 15.8 ml) is added with a stabilizer (tripolyphosphate in combination with one of the followings: pyrophosphate, hexametaphosphate, phytic acid, or citric acid, 6.4 wt % of the amount of MgSO₄). An amount of 28.57 g of MgSO₄·7H₂O, dissolved in 50 ml water is added at once to the above solution, the resulting mixture was blended for 30 seconds and added into the reactor. CO₂ is flushed through the solution in the reactor. Then the reactor is sealed, and the pressure is set to 15 bars for an overall time of 3 minutes. The reaction mixture is stirred by a mechanical rotor stirring shaft set at 1000 rpm to yield 6.3 g of white solid after precipitation with 50 ml ethanol. The product is isolated as is, without washing with deionized water and dried in the oven without vent to a constant L.O.D. of about 5.5%, XRD 100% AMC (˜55% yield for AMC).

The analytical results of the above-described examples are summarized in Table 1 and indicate several important issues. First, the presence of base is crucial to convert the CO₂ to carbonate and bicarbonate ions. In fact, the stoichiometry of the reactions with the alkaline earth metal salts, require at least 2 equivalents of base (OH⁻) to complete the chemical reaction. We have indications that higher level of base equivalents may be beneficial to reassure high yield of the amorphous products.

Without being bound to any particular theory, it is assumed that the base can directly react with CO₂ prior to the introduction of the alkaline earth metal salt. However, it can also react initially with the metal salt to form M-OH species (M=Ca or Mg), which are bases by themselves, which can then react with the CO₂. It means that if the industrial waste material is an alkaline earth metal hydroxide, CO₂ will be able to form the desired amorphous carbonates with no addition of base. However, to our knowledge, current industrial wastes containing calcium and magnesium consist of mainly alkaline earth metal chlorides and sulfates derived from the dissolution of rocks containing the metals in either sulfuric or hydrochloride acids. While the magnesium sulfate (Epsom salt) is very soluble and therefore can be used in the given examples, calcium sulfate (Gypsum) is a very insoluble material.

The presence of the base is also important to stabilize the as-formed amorphous carbonate in the reaction solution before it is isolated and dried. Our experience is that during large scale industrial processes of these amorphous carbonates, the process stage in which the amorphous product is still in suspension or wet, is very vulnerable toward crystallization through a solid-solution-solid crystallization mechanism. The presence of stabilizers but also basic pH levels are critical to suppress the crystallization at these process stages or if the amorphous products are deliberately used as suspensions for practical applications. In base solutions the solubility of the amorphous carbonate is dramatically reduced. In contrast, they are significantly more soluble in acidic and even neutral conditions, compared to their associated crystalline phases. Hence, in the given example, the pH of the reaction solution was kept at above pH 8.

The most commonly used bases are sodium hydroxide and dissolved ammonia (NH₄OH). In addition, these bases are also inexpensive and are produced in very large quantities. Processes based on one or the other bases will be decided on economic evaluation, availability, location and environmental factors associated with the industrial plants for making the invention products.

The presence of the stabilizer is very critical in the case of forming ACC as demonstrated in Example 20. The amount of the stabilizer and the sequence of its introduction is less important. In most examples 10% stabilizer was used, however, as seen from Example 2, 5% stabilizer is suitable too. The presence of a stabilizer in the formation of AMC is less critical to the capability of producing AMC that is stable in dry conditions as shown in Example 24. However, for long-term stability of AMC in humid environment or if suspended in aqueous solution in certain applications, a stabilizer is required as the stability of AMC is deteriorated drastically in the absence of a stabilizer, and it is rapidly crystallized. The generated ACC is very similar in its molecular arrangement in all the examples that give high yield, regardless of the variations in the synthesis. However, the chemical content of AMC and its molecular arrangement can be widely varied based on variable and order changes during its synthesis.

Furthermore, recent detailed studies employing advanced solid NMR techniques revealed that both amorphous and crystalline phases of magnesium carbonate possess also magnesium bicarbonate species and salts thereof (for example Leukel et al., Hydrogen Bonding in Amorphous Alkaline Earth Carbonates, Inorg. Chem. 2018, 57, 11289-11298; Moore et al., Quantitative Identification of Metastable Magnesium Carbonate Minerals by Solid-State ¹³C NMR Spectroscopy. Environ. Sci. Technol. 2015, 49, 657-664; and Tanaka et al., Transformation process of amorphous magnesium carbonate in aqueous solution. Journal of Mineralogical and Petrological Sciences, Volume 114, page 105-109, 2019). This is not very surprising considering the disordered structures of AMC and a bit more surprising in their presence in the crystalline phases.

Many stabilizers other that the exemplified ones can be used. Tripolyphosphate it is a very reliable stabilizer, very low cost and is used at very large quantities for food processing (preservation). Nevertheless, any one of the following stabilizers may be used polyphosphates, organic acids, phosphorylated amino acids, phosphorylated, phosphonated, sulfated or sulfonated organic compounds, phosphoric or sulfuric esters of hydroxy carboxylic acids, bisphosphonates, organic polyphosphates, polyphosphates, hydroxyl bearing organic compounds, derivatives thereof, proteins and any combinations thereof. more specific examples of the useful stabilizers are phosphoserine, citric acid, sodium triphosphate and citric acid, adenosine triphosphate, adenosine diphosphate, phytic acid, etidronic acid, pyrophosphate, polyphosphate, hexamethaphosphate, ethanol, a salt thereof and any combination thereof.

Furthermore, it may be found or produced around the locations where waste calcium and magnesium salts can be found during the production of phosphates from natural calcium phosphate minerals.

Although examples of mixed amorphous calcium-magnesium carbonates are not given, their formation as stable amorphous compositions is highly feasible as demonstrated recently in WO2022162667—Particles Comprising Amorphous Divalent Metal Carbonate.

Although the present invention has been described herein above by way of preferred embodiments thereof, it can be modified, without departing from the spirit and nature of the subject invention as defined in the appended claims.

TABLE 1
Elemental and component analysis of examples' products

| Experiment | | | | | Wt % | | | | | |
|---|---|---|---|---|---|---|---|---|---|---|
| name and | | Wt % | Wt % | | Carbone | Wt % | | | | |
| example | | Ca | Na, Cl | Wt % P | Dioxide | Water | Wt % OH | | | |
| No. | Synthesis Name | (ICP) | (ICP) | (ICP) | (TGA) | (TGA) | (TGA) | % ACC | Yield | L.O.D. |
| 1765-5 | ACC-Susp- | N/A | N/A | N/A | 30.7% | 39% | 4.3%; | 44% | 3.2 g | 12% |
| Example 1 | CO₂Bubbled 10 min- | % Ca | | | 707° C. | 94.30° C. | 2.4% | CCC + V + | 30% | |
| | STPP 10% Wt.- | | | | | | 305.56° C.; | ACC | | |
| | 2PACKS-2equivalents | | | | | | 469.03° C. | | | |
| | NaOH | | | | | | | | | |
| 1828 | ACC-Susp- | 39.7% | 1.1% | 2.10% | 35.1% | 4.7% | 4.1%; | 38% | 7.8 g | 12% |
| Example 2 | CO₂Bubbled 10 min- | Ca | Na | | 718° C. | 91° C. | 1.4% | CCC + V + | 73% | |
| | STPP 5% Wt.- | | 0.5% | | | | 190.° C.; | ACC | | |
| | 2PACKS-2eq NaOH | | Cl | | | | 297° C. | | | |
| 1766-4 | ACC-Susp- | 34.4% | 2.17% | 4.04% | 31.3% | 4.1% | 3.0%; | 41% | 5.5 g | 12% |
| Example 3 | CO₂Bubbled 10 min- | Ca | Na | | 717° C. | 96° C. | 1.9% | CCC + V + | 51% | |
| | STPP 10% Wt.- | | 0.5827% | | | | 300.° C.; | MHC | | |
| | 4PACKS-2equivalents | | Cl | | | | 480° C. | (minor) + | | |
| | NaOH | | | | | | | ACC | | |
| 1764 | ACC-Susp- | N/A | N/A | N/A | 2.0% | 10.8% | 4.9% | | | |
| Example 4 | CO₂Bubbled 5 min- | % Ca | | | 601° C. | 109° C. | 314° C. | | | |
| | STPP 10% Wt.- | | | | | | | | | |
| | 2PACKS-without | | | | | | | | | |
| | NaOH | | | | | | | | | |
| 1766-1 | ACC-Susp- | N/A | N/A | N/A | 2.1% | 9.3% | 4.2% | | | |
| Example 5 | CO₂Bubbled 40 min- | % Ca | | | 565° C. | 112° C. | 296° C. | | | |
| | STPP 10% Wt.- | | | | | | | | | |
| | 4PACKS-without | | | | | | | | | |
| | NaOH | | | | | | | | | |
| 1766-2 | ACC-Susp- | N/A | N/A | N/A | 1.8% | 8.4% | 2.5% | | | |
| Example 6 | CO₂Bubbled 10 min- | % Ca | | | 574.12° C. | 107° C. | 314° C. | | | |
| | STPP 10% Wt.- | | | | | | | | | |
| | 4PACKS-without | | | | | | | | | |
| | NaOH | | | | | | | | | |
| 1766-3 | ACC-Susp- | 23.9% | 4.0% | 23.2% | 1.3%; | 10.4% | 4.6%; | | | |
| Example 6 | CO₂Bubbled 20 min- | Ca | Na | | 691° C.; | 106° C. | 297° C.; | | | |
| | STPP 5% Wt. external | | 1.4% | | 1.2% | | 1.7% | | | |
| | added as solid-5% Wt. | | Cl | | 887° C. | | 552° C. | | | |
| | internal dissolved in | | | | | | | | | |
| | water-To a Total of | | | | | | | | | |
| | 10% Wt.-4PACKS- | | | | | | | | | |
| | without NaOH | | | | | | | | | |
| 1879 | ACC-Susp-1.37% Ca- | 34.3% | 2.44% | 3.1% | 32.0% | 7.6% | 6.0% | 90% ACC | 9.5 g | 12% |
| Example 7 | CO₂Bubbled 10 min- | Ca | Na | | 698° C. | 101° C. | 501° C. | CCC + V + | 89% | |
| | STPP 10% Wt.- | | 0.54% | | | | | ACC | | |
| | 2PACKS-3 equivalents | | Cl | | | | | | | |
| | NaOH | | | | | | | | | |
| 2019- | ACC-Susp-1.37% Ca- | 30.5% | 2.0% | 3.1% | | | | 75% ACC | 9.9 g | 11% |
| Example 7 | CO₂Bubbled 10 min- | Ca | Na | | | | | CCC + V + | 93% | |
| | STPP 0% Wt.- | | 0.5% | | | | | ACC | | |
| | 2PACKS-3 equivalents | | Cl | | | | | | | |
| | NaOH | | | | | | | | | |
| 1932 | ACC-Susp-1.37% Ca- | 44.9% | 1.8% | 3.8% | 10.3% | 5.1% | 2.5%; | MHC | N/A | 12% |
| Example 8 | CO₂Bubbled 5 min-Atm | Ca | Na | %P | 631° C. | 99° C. | 191.97° C.; | MHC + ACC | | |
| | Pressure-STPP | | 0.8% | | | | 11.7% | | | |
| | 10% Wt.-2ACKS-3eq | | Cl | | | | 423° C. | | | |
| | NaOH | | | | | | | | | |
| 2018 | ACC-Susp-1.72% Ca- | 32.7% | 2.3% | 2.4% | | | | 66% ACC | 9.5 g | 12% |
| Example 9 | CO₂Bubbled 10 min- | Ca | Na | | | | | CCC + V + | 89% | |
| | STPP 10% Wt.- | | 0.4% | | | | | ACC | | |
| | 2PACKS-3 equivalents | | Cl | | | | | | | |
| | NaOH | | | | | | | | | |
| 2098 | ACC-Susp-1.37% Ca- | 32.1% | 3.4% | 3.%5 | | | | 54% ACC | 6.9 g | 12% |
| Example 10 | CO₂Bubbled 10 min- | Ca | Na | | | | | MHC + V + | 64% | |
| | Reactor 10 bars-STPP | | 0.9% | | | | | ACC | | |
| | 10% Wt.-2PACKS-3 eq | | Cl | | | | | | | |
| | NaOH | | | | | | | | | |
| 2099 | ACC-Susp-1.37% Ca- | 40.6% | 2.3% | 3.8% | | | | MHC | N/A | 12% |
| Example 11 | CO₂Bubbled 10 min- | Ca | Na | | | | | MHC+ ACC | 7.1 g | |
| | Reactor 10 bars-STPP | | 0.8% | | | | | | | |
| | 10% Wt.-4PACKS-3 eq | | Cl | | | | | | | |
| | NaOH | | | | | | | | | |
| 2100 | ACC-Susp-1.37% Ca- | 36.5% | 1.1% | 4.5% | | | | 84% ACC | 6.7 g | 12% |
| Example 12 | CO₂Bubbled 10 min- | Ca | Na | | | | | MHC + V + | | |
| | Reactor 10 bars-STPP | | 1.5% | | | | | ACC | | |
| | 10% Wt.-2PACKS-2 eq | | Cl | | | | | | 63% | |
| | NaOH | | | | | | | | | |
| 2101 | ACC-Susp-1.37% Ca- | 36.8% | 1.2% | 4.8% | | | | 69% ACC | 6.7 g | 11% |
| Example 13 | CO₂Bubbled 10 min- | Ca | Na | | | | | MHC + V + | 63% | |
| | Reactor 10 bars-STPP | | 1.6% | | | | | ACC | | |
| | 10% Wt.-4PACKS-2 eq | | Cl | | | | | | | |
| | NaOH | | | | | | | | | |
| 2132 | ACC-Susp-1.37% Ca- | 33.7% | 1.9% | 4.0% | | | | 48% ACC | 7.7 g | 11% |
| Example 14 | STPP 5 Wt. % 2eq | Ca | Na | | | | | CCC + V + | 72% | |
| | NaOH.-Reactor CO₂10 | | 0.7% | | | | | ACC | | |
| | min 20 bars- | | Cl | | | | | | | |
| | CaCl₂•2H₂O(s)-STPP(s) | | | | | | | | | |
| | 5 Wt. %-Homogenizer | | | | | | | | | |
| | at Atm. Pressure | | | | | | | | | |
| 2133 | ACC-Susp-1.37% Ca- | 31.3% | 2.9% | 3.0% | | | | 72% ACC | 10.4 g | 11% |
| Example 15 | STPP 5 Wt. % 3eq | Ca | Na | | | | | CCC + V + | 97% | |
| | NaOH.-Reactor CO₂10 | | 0.7% | | | | | MHC | | |
| | min 20 bars- | | Cl | | | | | (minor) + | | |
| | CaCl₂•2H₂O(s)-STPP(s) | | | | | | | ACC | | |
| | 5 Wt.%-Homogenizer | | | | | | | | | |
| | at Atm. Pressure | | | | | | | | | |
| 2134 | STPP 5 Wt. % 2eq | 35.4% | 1.6% | 4.1% | | | | 23% ACC | 7.6 g | 11% |
| Example 16 | ACC-Susp-1.37% Ca- | Ca | Na | | | | | CCC + V + | 71% | |
| | NaOH.-Reactor CO₂10 | | 1.2% | | | | | ACC | | |
| | min 20 bars- | | Cl | | | | | | | |
| | CaCl₂•2H₂O-STPP5 | | | | | | | | | |
| | Wt.%-Homogenizer at | | | | | | | | | |
| | Atm. Pressure | | | | | | | | | |
| 2135 | ACC-Susp-1.37% Ca- | 33.7% | 2.0% | 3.4% | | | | 37% ACC | 9.8 g | 12% |
| Example 17 | STPP 5 Wt. % 3eq | Ca | Na | | | | | V + ACC | 92% | |
| | NaOH.-Reactor CO₂10 | | 0.5% | | | | | | | |
| | min 20 bars- | | Cl | | | | | | | |
| | CaCl₂•2H₂O-STPP5 | | | | | | | | | |
| | Wt. %-Homogenizer at | | | | | | | | | |
| | Atm. Pressure | | | | | | | | | |
| 2020-2 | ACC-Susp-1.37% Ca- | 23.1% | 0.3% Na | 20.3% | 3.0%. | 11.8% | 3.7%. | | | |
| Example 18 | CO₂Bubbled 10 min- | Ca | 3.0% Cl | | 544.° C. | 115° C. | 302° C. | | | |
| | Reactor 10 bars-STPP | | | | | | | | | |
| | 10% Wt.-2PACKS-No | | | | | | | | | |
| | NaOH | | | | | | | | | |
| 2020-1 | ACC-Susp-1.37% Ca- | 24.2% | 0.3% Na | 21.7% | 2.720% | 11.85% | 3.486%; | | | |
| Example 19 | CO₂Bubbled 10 min- | Ca | 2.3% Cl | | 617.88° C. | 116.02° C. | 309.50° C. | | | |
| | Reactor 20 bars-STPP | | | | | | | | | |
| | 10% Wt.-2PACKS-No | | | | | | | | | |
| | NaOH | | | | | | | | | |
| 2294 | ACC-Susp-1.37% Ca- | 37% | 1.3% | 0.02 | | | | 15% ACC | 8.5 g | 6% |
| Example 20 | CO₂Bubbled 10 min- | Ca | Na | | | | | CCC | 80% | |
| | STPP 0% Wt.- | | 0.3% | | | | | | | |
| | 2PACKS-3 equivalents | | Cl | | | | | | | |
| | NaOH | | | | | | | | | |
| 2295 | ACC-Susp-1.37% Ca- | 38.3% | 0.4% | <0.01 | | | | 11% ACC | 6.5 g | 6% |
| Example 21 | CO₂Bubbled 10 min- | Ca | Na | | | | | CCC | 61% | |
| | Reactor 10 bars-STPP | | 0.2% | | | | | | | |
| | 0% Wt.-2PACKS-2 eq | | Cl | | | | | | | |
| | NaOH | | | | | | | | | |
| 2094 | | | | | | | | | | |
| 2730 | ACC-Susp-1.37% Ca- | 32.9% | 0.1% | 4.1% | 26.6% | 155% | 4.1%. | 100% ACC | 8.8 g | 10.3% |
| Example 21 | CO₂) Bubbled 10 min- | Ca | Na | | 735° C. | 90° C. | 381; | | 82% | |
| | Reactor 10 bars-STPP | | 0.5% | | | | 467° C. | | | |
| | 10% Wt.-2PACKS-2 eq | | Cl | | | | | | | |
| | NH₄OH | | | | | | | | | |
| 2754 | AMC-Susp-1.13% Mg- | | | | 17.8% | 3.881% | 7.431%. | 100% AMC | 1 g | 4.7% |
| Example 22 | CO₂(g) Bubbled 3 min- | | | | 607° C. | 92.82° C. | 204.48° C. | | 6% | |
| | Reactor 15 bars-STPP | | | | 691° C. | | | | | |
| | 6.4% Wt.-2PACKS- | | | | | | | | | |
| | NH₄OH 2 equivalents | | | | | | | | | |
| 2755 | AMC-Susp-1.13% Mg- | | | | 21.5% | 14.0% | N/A | 100% AMC | 1.5 g | 5.1% |
| Example 23 | CO₂Bubbled 5 min- | | | | 656° C. | 103° C. | | | 9.4% | |
| | Reactor 15 bars-STPP | | | | | | | | | |
| | 6.433% Wt.-2PACKS- | | | | | | | | | |
| | NH₄OH 2 equivalents | | | | | | | | | |
| 2761 | AMC-Susp-1.13% Mg- | | | | 5.3% | 15.1% | 37.6% | Mostly | 1.1 g | 3.6% |
| Example 24 | CO₂ Bubbled 5 min- | | | | 300° C. | 105° C. | 459° C. | AMC + | 6% | |
| | Reactor 15 bars-STPP | | | | | | | Nesquehonite | | |
| | 0% Wt.-2PACKS- | | | | | | | (Minor) | | |
| | NH₄OH 2 equivalents | | | | | | | | | |
| 2766 | AMC-Susp-1.127% | 18.4% | N/A | 3.5 | N/A | 21.7% | 22.7% | 100% AMC | 6.3 g | 5.4% |
| Example 25 | Mg-CO₂) Bubbled | Mg | % Na | | | 97° C. | 482° C.; | | 55% | |
| | 5 min-Reactor 15 bars- | | 0.05% | | | | 587° C. | | | |
| | STPP 0% Wt.- | | Cl | | | | | | | |
| | 2PACKS-NH₄OH 2 | | 4.7% | | | | | | | |
| | equivalentsNo | | S | | | | | | | |
| | Washings | | | | | | | | | |

Footnote:
4 PACKS Solution: Half of the amount of the stabilizer i.e. 5 wt. % is dissolved in the CaCl₂•2H₂O solution yielding Solution (I). Whilst the other half left amount of the stabilizer i.e. 5 wt. % is dissolved in the basic solution comprising of NaOH or NH4OH yielding solution (II). The resulting reaction solution includes the mixing of solutions (I) + (II).
2 PACKS Solution: All the amount of the stabilizer i.e., 10 wt. % is solely dissolved in the basic solution i.e., NaOH or NH4OH.

1-44. (canceled)

45. A method of preparing a stabilized amorphous alkaline earth metal carbonate, the method comprising:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; or
adding a salt of an alkaline earth metal into the solution obtained in step (i) followed by bubbling or pressurizing CO₂ gas into the solution,
thereby precipitating an amorphous alkaline earth metal carbonate;
(iii) collecting the resulting amorphous alkaline earth metal carbonate precipitate; and
(iv) adding at least one stabilizer in at least one of the following stages: (a) before bubbling or pressurizing CO₂ gas; (b) after bubbling or pressurizing CO₂ gas; (c) before adding the salt of an alkaline earth metal, (d) together with adding the salt of an alkaline earth metal, or (e) after adding the salt of an alkaline earth metal.

46. The method of claim 45, further comprising:
(i) dissolving a base in an aqueous solution, wherein the resulting solution has a pH equal to or above 8;
(ii) bubbling or pressurizing CO₂ gas into the solution obtained in step (i) followed by adding a salt of an alkaline earth metal; and
(iii) collecting the resulting stabilized amorphous alkaline earth metal carbonate precipitate,
(iv) adding a stabilizer at a stage selected from (a) before bubbling or pressurizing CO₂ gas into the solution obtained in step (i), (b) after adding the salt of an alkaline earth metal, or (c) both (a) and (b).

47. The method of claim 45, further comprising:
(i) dissolving a base in an aqueous solution, wherein the resulting solution has a pH equal to or above 8;
(ii) adding the salt of an alkaline earth metal into the solution obtained in step (i) followed by bubbling or pressurizing CO₂ gas into the solution;
(iii) collecting the resulting stabilized amorphous alkaline earth metal carbonate precipitate; and
(v) adding a stabilizer at a stage selected from (a) together with adding the salt of an alkaline earth metal; (b) before bubbling or pressurizing CO₂ gas, or (c) both (a) and (b).

48. The method of claim 45, wherein the base is selected from a hydroxide of an alkali metal, ammonia, or ammonium hydroxide.

49. The method of claim 48, wherein the (i) hydroxide of an alkali metal is sodium hydroxide, (ii) the salt of an alkaline earth metal is selected from a water-soluble halide, nitrate, and sulphate salt of the alkaline earth metal, and hydrates thereof, or (iii) both (i) and (ii).

50. The method of claim 49, wherein the alkaline earth metal salt is selected from calcium chloride, calcium bromide, calcium nitrate, magnesium chloride, magnesium sulfate, magnesium nitrate and a combination thereof, optionally wherein the combination of the alkaline earth metal salt comprises a combination of calcium and magnesium salt and wherein the salts are water-soluble salts.

51. The method of claim 50, wherein the alkaline earth metal salt is calcium chloride.

52. The method of claim 51, further comprising adding from 0.03 M to 0.8 M of calcium chloride.

53. The method of claim 50, wherein the alkaline earth metal salt is magnesium chloride.

54. The method of claim 53, further comprising adding from 0.04 M to 1 M of magnesium chloride.

55. The method of claim 45, wherein the stabilizer is selected from the group consisting of polyphosphates, inorganic polyphosphates, organic acids, phosphorylated amino acids, phosphorylated, phosphonated, sulfated or sulfonated organic compounds, phosphoric or sulfuric esters of hydroxy carboxylic acids, bisphosphonates, organic polyphosphates, polyphosphates, hydroxyl bearing organic compounds, derivatives thereof, proteins and any combinations thereof.

56. The method of claim 45, wherein:
(i) the pH is maintained at the value equal to or above 8, equal to or above 9, equal to or above 10, equal to or above 11, or equal to or above 12 during the whole process of preparation
(ii) wherein the concentration of the base added is at least 2 molar equivalents of the concentration of the alkaline earth metal salt
(iii) the total amount of the stabilizer added is from 2 to 15 wt % of the amount of the alkaline earth metal salt
(iv) the reaction is performed at atmospheric pressure or under the pressure from 1 to 60 bars
(v) the reaction is performed at ambient temperature
(vi) collecting the stabilized amorphous alkaline earth metal carbonate comprises filtering and drying the resulting precipitant of stabilized amorphous alkaline earth metal carbonate
(vii) the precipitation of the alkaline earth metal carbonate is accomplished within 2 minutes.

57. The method of claim 45, further comprising:
(i) dissolving a base and sodium tripolyphosphate as a stabilizer in an aqueous solution, wherein the pH of the resulting aqueous solution is 8 or more;
(ii) bubbling or pressurizing CO₂ into the solution obtained in step (i) followed by adding a CaCl₂) or MgSO₄ and optionally adding sodium tripolyphosphate as a stabilizer to the solution;
(iii) optionally adding sodium tripolyphosphate as a stabilizer to the solution obtained in step (ii), and
(iv) collecting the resulting stabilized amorphous calcium carbonate,
wherein the base is selected from NaOH and NH₄OH and is added in the amount equal to at least 2 equivalents of CaCl₂) and optionally wherein CaCl₂) is selected from anhydrous, monohydrate and dihydrate CaCl₂).

58. The method of claim 45, further comprising:
(i) dissolving a base and sodium tripolyphosphate as a stabilizer in an aqueous solution, wherein the pH of the resulting aqueous solution is 8 or more;
(ii) adding CaCl₂) or MgSO₄ followed by bubbling or pressurizing CO₂ gas;
(iii) optionally adding sodium tripolyphosphate as a stabilizer to the solution obtained in step (ii), and
(iv) collecting the resulting stabilized amorphous calcium carbonate,
wherein the base is selected from NaOH and NH₄OH and is added in the amount equal to at least 2 equivalents of CaCl₂) and optionally wherein CaCl₂) is selected from anhydrous, monohydrate or dihydrate CaCl₂).

59. The method of claim 57, further comprising adding the stabilizer at step (iii).

60. The method of claim 58, further comprising adding the stabilizer at step (iii).

61. A method of preparing a stabilized amorphous alkaline earth metal carbonate, the method comprising:
providing an aqueous solution having a pH equal to or above 8 and: (i) continuously adding to the aqueous solution a base, at least one stabilizer, and an alkaline earth metal, (ii) continuously bubbling or pressurizing CO₂ gas into the solution, and (iii) continuously collecting the resulting amorphous alkaline earth metal carbonate precipitate, wherein the pH is constantly maintained equal to or above 8 during the whole process.

62. The method of claim 61, wherein alkaline earth metal is calcium or magnesium and step (i) comprises adding calcium chloride or magnesium sulfate, respectively.

63. A stabilized amorphous alkaline earth metal carbonate prepared by the method according to claim 45.

64. A stabilized amorphous alkaline earth metal carbonate prepared by the method according to claim 61.
